(19) United States
(12) Patent Application Publication
(10) Pub. No.: US 2018/0219917 A1
(43) Pub. Date: Aug. 2, 2018

(54) RECOMMENDATIONS FOR SECURITY ASSOCIATED WITH ACCOUNTS

(71) Applicant: PCMS Holdings, Inc., Wilmington, DE (US)

(72) Inventor: Mung Chiang, Princeton, NJ (US)

(73) Assignee: PCMS Holdings, Inc, Wilmington, DE (US)

(21) Appl. No.: 15/747,434

(22) PCT Filed: Jul. 22, 2016
(86) PCT No.: PCT/US2016/043649

§ 371 Date: Jan. 24, 2018

Related U.S. Application Data
(60) Provisional application No. 62/196,688, filed on Jul. 24, 2015.

(51) Int. Cl. H04L 29/06; G06Q 10/06

(52) U.S. Cl. CPC H04L 63/20; G06Q 10/0635; H04L 63/1433

(57) ABSTRACT

Systems, methods, and/or instrumentalities for creating and/or enabling creation of security profiles are described herein. The security profiles may be created for a user and/or for various entities that the user may interact with. The security profiles may be retrieved when the user accesses a first one of the entities (e.g., a website). The security profile may be used to provide the user with a warning when the user may submit information, credentials, a security answer, and/or the first one of the entities that may provide access to a second one of the entities, thereby compromising the second one of the online entities.

### CROSS-REFERENCE TO RELATED APPLICATIONS

This application claims priority to U.S. provisional patent application No. 62/196,688, filed Jul. 24, 2015, which is hereby incorporated by reference herein.

### BACKGROUND

Today, a person or user may engage in several online activities with various online entities, e.g., from online banking and shopping to social networks and communications. An entity such as an online bank may put security measures in its own system, but information such as a username, password, security question and answer, and/or the like that may be used to authenticate the person or user with the system may not be secure itself. For example, a user may re-use a username, password, security question and answer, and/or the like across multiple accounts, entities, and/or websites. Those accounts, entities, and/or websites may use similar or different techniques or methods to retrieve a lost password or a lost username or an identifier (ID). Unfortunately, when those multiple accounts use such lost password or lost username or ID retrieval techniques or methods, and/or when a user re-uses a username, password, security question and answer, and/or the like, current security techniques or methods may be defeated.

### SUMMARY

Systems, methods, and/or instrumentalities for managing online security, including creating and/or using security profiles (e.g., vendor security profiles, user security profiles, etc.) to make recommendations to users and/or entities (e.g., online service providers) about security risks, may be provided and/or described herein. A vendor security profile may be associated with an entity that a user may interact with. A user security profile may be associated with a user and may depict the user's interactions and/or security exposure to multiple entities. For example, a first vendor security profile may be created in association with a first entity (e.g., a first website), and a second vendor security profile may be created in association with a second entity (e.g., a second website). The vendor security profiles may include information about actions or data elements that may be used to obtain access to the respective entities. The vendor and/or user security profiles may be stored at a server (e.g., in a repository, in memory, etc.) and/or be used to assess the user's or the entities' exposure to security risks. For example, the first and second vendor security profiles and/or a user security profile, which may be in the form of a security graph (e.g., including an overlay graph), an adjacency list, and/or another similar data structure (e.g., that may be in XML), may be created and stored. The vendor security profiles may be retrieved and/or received, for example by a server (e.g., which provides a cloud-based service) or a local device (e.g., a mobile device or a personal computer associated with the user) when the user accesses a first entity (e.g., a first website). The vendor security profiles may be used (e.g., by the server or the local device) to determine whether there is a security risk to the user and, for example, to indicate (e.g., provide a user with) a warning when the user may send security information (e.g., credentials, a security answer, and/or the like) to the first website that may provide an unauthorized person with access to a second entity such as a second website (e.g., compromising the user's account for the second website and/or the security information associated with the second website). For example, information associated with the user may be received at the server or the local device. The information may include first security information associated with the first entity that may be used by the user to access the first entity. The information may include second security information associated with the second entity that may be used by the user to access the second entity. The first and/or second security information may include an access value (e.g., a login, a password, credit card information, etc.). The server or the local device may determine whether there is a security risk to the user based on a relationship between the first vendor security profile, the second vendor security profile, the first security information, and/or the second security information. For example, the server or the local device may determine that a security risk exists that access to one of the entities may be obtained by using the access value associated with the other of the entities. Based on a determination that the security risk exists, the server or the local device may provide a warning to the user about the security risk. As described herein, one or more of the features described above may be implemented in a remote server (including multiple servers) and/or an end user device.

The Summary is provided to introduce a selection of concepts in a simplified form that may be further described below in the Detailed Description. This Summary is not intended to identify key features or essential features of the claimed subject matter, not is it intended to be used to limit the scope of the claimed subject matter. Furthermore, the claimed subject matter is not limited to the examples herein that may solve one or more disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1 depicts an example of a vendor security profile template that may be used in one or more of the embodiments described herein.

FIG. 2 illustrates an example of a graph (e.g., a basic graph) with probabilities of security risks as described herein.

FIG. 3 illustrates an example of an overlay graph as described herein.

FIG. 4 illustrates an example of an updated graph as described herein.

FIGS. 5-6 illustrate examples of adding a new user account and updating a user security profile as described herein.

FIGS. 7-8 illustrate examples of developing and maintaining a template repository as described herein.

FIG. 9 illustrates an example of updating a user security profile and/or an account as described herein.

FIG. 10 shows an example flow diagram depicting example actions that may be taken in one or more disclosed examples.

FIGS. 11A and 11B illustrate example systems in which one or more disclosed examples may be implemented.

FIG. 12A depicts a diagram of an example communications system in which one or more disclosed examples may be implemented.

FIG. 12B depicts a system diagram of an example radio access network and an example core network that may be used within the communications system illustrated in FIG. 12A.

FIG. 12C depicts a system diagram of another example radio access network and an example core network that may be used within the communications system illustrated in FIG. 12A.

FIG. 12D depicts a system diagram of another example radio access network and an example core network that may be used within the communications system illustrated in FIG. 12A.

### DETAILED DESCRIPTION

A detailed description of illustrative embodiments may now be described with reference to the various Figures. Although this description provides a detailed example of possible implementations, it should be noted that the details are intended to be exemplary and in no way limit the scope of the examples described herein.

Examples herein (e.g., systems, methods, and/or instrumentalities) may enable quantification and/or fortification of security for an overall system (e.g., an online system). The overall system may include multiple entities, some or each of which may have different degrees of security. The inter-dependence and/or relationship among these entities may be defined and/or depicted through one or more vendor security profiles (e.g., data structures and/or graphical representations such as graphs) associated with the entities and/or a user security profile (e.g., a master user security profile) associated with a user who interacts with the entities. Quantified assessment of security risks and/or systematic design of fortification may be provided (e.g., which may enhance security and/or privacy of a user).

An example system (e.g., a recommendation system) as described herein may be set up and may operate as follows (e.g., via a web service and/or a mobile app). During initialization, a user may select an entity (e.g., an online service provider) to which the user may provide security information. For example, the user may select the entity by choosing from a menu of the most popular online services. The user may access the menu, for example by visiting a website, or using an application installed and running on a device (e.g., a mobile device) associated with the user. Once the entity has been selected, a vendor security profile may be created and/or configured for the entity (e.g., via a configuration process). The creation of the vendor security profile may be based on information collected from public domain. The information may include, for example, the entity's security/privacy policies (e.g., what credentials are required to authenticate a user, what credentials are required to change account settings, etc.). Once created, the vendor security profile may be stored in a repository (e.g., in the cloud or on one or more individual devices). The stored vendor security profile may be managed (e.g., updated upon detecting policy changes at the entity) and/or analyzed (e.g., to compute or derive recommendations for the user or the entity). The storage and/or computation or derivation of recommendation may take place in the cloud or on individual devices (e.g., end user devices). In the case of using cloud, communication to multiple devices may take place. In the case of using individual devices, consistency update across the devices may be performed (e.g., on a regular basis). Recommendations and/or warnings may be provided to the user and/or the entity, for example, based on an analysis of the vendor security profile and/or user activities. The recommendations and/or warnings may be provided in real-time and/or over a long timescale (e.g., through periodic alerts or suggestions). In either or both scenarios, the recommendations and/or warnings may be presented to the user via a user interface (e.g., a display on an end user device) and/or bundled into email/text alerts (e.g., which may be sent on a regular basis).

A user security profile may be created, for example, to depict the user's interactions and/or security exposure to one or more entities (which may have respective vendor security profiles). The user security profile may be stored in a repository (e.g., the same repository as the vendor profile repository or a different repository). The user security profile may be used to quantify and/or assess a user's exposure to security risks (e.g., based on the user's interactions with various entities and/or the relationship or inter-dependence among the entities). The user security profile may be monitored and/or updated, for example, based on the user's activities (e.g., exchanging security information with an online entity) and/or policy changes at one or more of the entities.

As described herein, a user may engage in activities with various entities (e.g., online entities such as websites). These entities may include, for example, online banking and shopping sites, social networks, communication systems or services, and/or the like. The user may maintain respective accounts with these entities. In examples, an entity such as an online bank may be secure in its own system, but may not know whether the information (e.g., a username and/or password) it receives for authentication is secure. For example, the entity may assume that the information it receives for authentication is secure while such information may not be secure. A hacker may be able to access or even change such information and pretend to be the legitimate user. Fusion of multiple attacks on different entities may be a concern for at least some networks (e.g., such a big data network).

Certain entities may allow security data elements such as a billing address of a user and/or account information (e.g., an access value such as the last four digits of a credit card number associated with the user) to be used to log into an account of the user. In an example, the billing address and/or the account information may be used to retrieve a lost password and/or username or ID. A user (e.g., even an illegitimate user or hacker) may supply the billing address and prompt the service provider of the account to issue a temporary password. The temporary password may then be used to gain access to the account. In an example, account information such as the last four digits of a credit card that may be used to receive a temporary password from a first provider or entity may be unimportant to a second provider or entity. The account information (e.g., the last four digits of the credit card) may be displayed on the second provider or entity when an account with that provider or entity is accessed. The account information may be seen and used by a potential hacker to breach an account with the first provider or entity. As such, information that may be used to access an account and may be assumed to be secure by one provider and/or entity may actually not be secure (e.g., may be displayed by another provider).

Network threats and/or their associated behaviors may be determined. Sensor data may be acquired (e.g., through a variety of sensors such as those in mobile devices, healthcare devices, or smart transportation vehicles) that identifies a specific contact. The acquired sensor data may be normalized to generate transformed sensor data. A contact behavior feature vector may be derived for one or more of a plurality of time periods (e.g., for each of the plurality of time periods). Scores associated with one or more of a plurality of classification modules (e.g., with each of the plurality of classification modules) may be determined to form a contact score vector. The type of the specific contact may be identified based on the contact score vector. A threat type may be determined based on a contact behavioral profile and/or the contact score vector. While certain behaviors may be extracted from the sensor data, total security analysis and design may require more than the sensor data. The total security analysis and design may address, for example, problems with information reuse (e.g., usernames, passwords, security questions and answers, etc.) and/or public display of account information by one entity that may be deemed secure by another entity (e.g., the information may be used to redeem or retrieve a lost password or username or ID).

The security vulnerability of a network may be assessed. For example, a system object model database may be created and may support the information data requirements of a disparate network vulnerability analysis program. Goal oriented fuzzy logic decision rules may be applied to determine the vulnerability posture of the network. For example, fuzzy logic decision rules may be applied to a physical computer network. Graph-based analysis or design rules may be used to address the vulnerability of an information network. In examples, a graph-based approach as described herein may be used to illustrate complex and/or general dependence.

Data may be classified for use in data fusion processes. Data may be classified selectively (e.g., by grouping nodes of a classification tree). A node may be assigned to one of a plurality of groups such that at least one of the groups may include at least two of the nodes. Data may be classified based on the classification tree, the selective grouping of the nodes, and/or the results displayed. Group assignment may be provided in data classification through a conceptual graph (e.g., in the form of a tree). A graph-based approach, and more generally, data structures including various types of graphs as described herein (e.g., which may include a tree-based graph), may be used to illustrate complex and general dependence.

Protection of private information may be performed in a consistent and/or coordinated manner among multiple security regimes and/or entities. As described herein, a user may re-use account information that may not be secure across multiple entities or multiple accounts. For example, when multiple user accounts use different security regimes or techniques (e.g., such as different “lost password” or “lost user account ID” regimes), or when users re-use usernames and passwords across multiple services, certain security measures (e.g., including some online and brick and mortar account access security techniques) may be circumvented or defeated, e.g., by a hacker. Systems, methods, and instrumentalities may be provided to identify private data elements (e.g., access values such as social security numbers and/or credit card numbers), to reset and/or access accounts (e.g., such that awareness of high risk data elements may be increased), and/or to recommend that certain data be withheld and/or obfuscated (e.g., in order to strengthen an individual's private information profile across the user's web presence).

Vendor and/or user security profiles (e.g., in the form of directed, weighted graphs) may be generated or constructed to depict the dependence (e.g., relationship) of security information. A vendor security profile may be associated with an entity to which the user is providing or has provided security information (e.g., to register an account). A user security profile (e.g., a master user security profile) may be associated with a user, and may depict a user's association and/or exposure to various entities. A security profile (e.g., a vendor security profile or a user security profile) may take different forms, for example, for visualization purposes. For example, the security profile may be in the form of a graph (e.g., a directed and/or weighted graph), a list (e.g., an adjacency list), a set (e.g., a bipartite sets), and/or the like. When the graph form is used, the profile may include nodes. The nodes may include, for example, one or more of the following: attributes, keys, data elements, information fields (e.g., stored in different online entities), and/or actions that may be taken by the user to gain access to the entity. The graph may represent relationships among data points, for example through links.

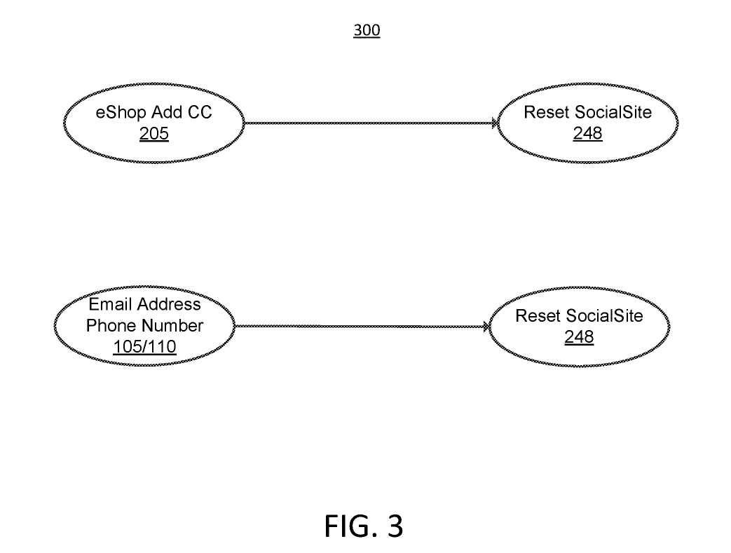

A transformed graph (e.g., based on a basic graph) may be created. For example, the transformed graph may take two end points of a path from an existing graph as two nodes (e.g., as shown in FIG. 3), and the paths between them as links. Using the transformed graph, an overlay multi-graph may be created. The overlay multi-graph may illustrate and/or highlight certain end-to-end security risks.

One or more weights may be assigned to a node and/or a link in a graph (e.g., a basic graph or an overlay graph). The weights may represent assessed risks and/or levels of difficulty in accessing a piece of information or taking an action upon obtaining access to another piece of information or another action (e.g., such as a risk that a user's driver license number can be obtained and used to change a login password of the user). An end-to-end security measurement and/or rating may be provided, for example, by multiplying the probabilities of risks across the links along a given path of a graph (e.g., a multi-graph). For example, if the probability of getting a user's driver license number is 20% and the probability of getting an online help desk to change the user's password is 30%, and if the two events are independent of each other, the probability of having both events happen may be 20%×30%=6%. Once created, the graph may be monitored and/or modified such that weak spots in the overall system may be fortified and/or improved. For example, a design of a graph (e.g., such as a new graph) may start from an existing graph. Additional links or nodes may be added. Existing links or nodes may be deleted. Link weights (e.g., subject to resource constraints) may be changed.

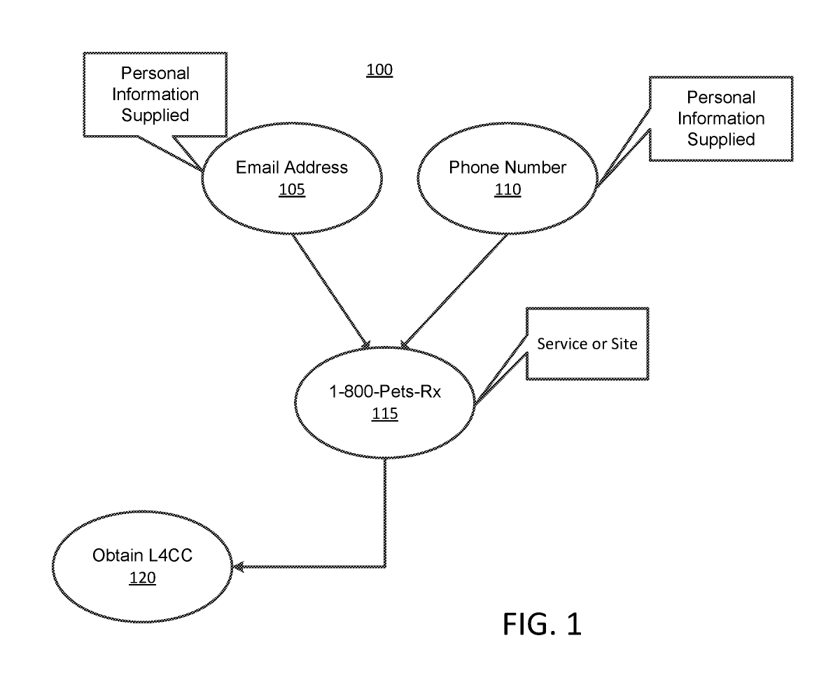

As described herein, a security profile may be created for an entity (e.g., a vendor security profile) and/or a user (e.g., a master user profile). A template for the security profile may be created or identified. The template may take different forms. For example, the template may be in the form of a structured graph. Information (e.g., sensitive information) related to online and/or offline services, and/or client accounts may be included in the security profile (e.g., a security profile graph). The information may be stored and used, e.g., for determining an identity to access the account and/or to change a property of the account (e.g., access values such as username or ID or password reset by various vendors/businesses). FIG. 1 illustrates an example of a template 100 (e.g., a graph). As shown, the template 100 may include security information, such as personal information 105, 110 (e.g., access values) that may be used to authenticate a user to a service or entity 115 (e.g., referred to herein as two-factor authentication). The personal information 105, 110 may be linked with personal information 120 such that the information 120 may be obtained using information 105, 110, e.g., as described herein.

The template (e.g., in the form of a graph) may include one or more nodes that may represent user private data elements (e.g., last four digits of a social security number), actions (e.g., changing a phone number), outcome (e.g., a password reset), services or entities (e.g., online shopping sites), and/or the like. The nodes may represent a combination of the foregoing. The template (e.g., in the form of a graph) may include links between the nodes. The links may represent logical connections between elements (e.g., nodes) within the template. For example, a link may represent verification or identification of user rights for changing or accessing private information. The links may be assigned respective weighted ratings. The weighted ratings may be based on, for example, the likelihood of obtaining access permissions to personal information in accordance with the security policies (e.g., hard or soft polices) of a particular service, business, or entity.

The templates (e.g., graphs) may be stored in a repository. The templates (e.g., graphs) may be loaded into a computer memory (e.g., temporarily stored in memory for processing purposes). The stored templates may be indexed (e.g., by service, enterprise, provider, web uniform resource locator (URL), and/or the like). A stored security profile (e.g., such as a vendor security profile) may be retrieved (e.g., in real time and/or similar to retrieving information, e.g., from a remote server, such as an online service, or from local memory), and may be used as described herein. For example, when a user creates a new account or accesses an existing account, one or more stored security profiles (e.g., vendor security profiles) may be retrieved and used to build and maintain a custom total user security rating profile (e.g., a master user profile that depicts security processes and/or measures of multiple entities with which the user is associated).

A centralized system and/or a local device may be utilized to create, update, and/or monitor vendor and/or user security profiles (e.g., via a user profile management session). The centralized system may be a remote server, for example. The local device may be a device (e.g., a personal computer, a mobile device, etc.) of the user. The security profiles may be created and/or updated based on one or more of the following: templates from the repository, data provided by the user, and/or the like. Information in the security profile may be interconnected (e.g., in a manner determined by the template or the active user session). The security profiles may include links identifying the local connections between nodes. The centralized system and/or local device may provide and/or include real-time analysis of a specific security profile (e.g., a vendor security profile). For example, real-time analysis may be conducted to determine the sensitivity of the information being requested and/or shared.

One or more of the following may be enabled: a quantified privacy/security profile (e.g., a quantified user security profile or a quantified vendor security profile) and/or a real-time recommendation service. The quantified privacy/security profile may be generated and/or created to highlight potential risks to privacy breaches. For example, a graph representing the privacy/security profile may be transformed to a reduced model (e.g., to a model made up of two end points). A risk exposure may be mathematically calculated by leveraging information from a first node to a last node. Real-time recommendations may be generated that may indicate specific weaknesses in the overall security profile (e.g., for an entity and/or for a user). Recommendations may be provided for how to improve the security posture of the security profile. For example, the recommendations may be to eliminate particular user accounts, and/or to obfuscate identifiable information (e.g., providing a particular vendor with alternate credit card numbers, or inaccurate information).

Quantitative awareness of a person's online risk exposure may be created. The risk exposure may be monitored. For example, the person's risk exposure may be monitored continuously as different online companies change their security policies (e.g., vendor security profile, which may be a website security profile). The person may be made aware of the changes in the online companies' security policies (e.g., as reflected in vendor security profiles associated with the online companies) and/or any implications in the user's security profile. The person may be alerted about the changes and implications, e.g., via periodic email or text alerts. For example, when the user signs up for a new email address, the user may register the new email address with the security system/service described herein, and in turn receive a warning (e.g., via an email or text alert) that an optional two-factor authentication should be activated for the new email service to prevent a security risk for her overall security profile. The online companies may also be informed of potential implications (e.g., implications to user privacy protection) that may arise from the inter-connections of the user's online presence. For example, the online companies may be notified that certain privacy policies should be changed, certain dependencies should be disallowed, certain new dependencies should be added, and/or the like. The notification may be performed in real time and/or via periodic communications (e.g., such as periodic email or text alerts).

The vendor and/or user security profiles (e.g., in the form of a graph) described herein may be obtained and/or built from known security profiles and/or policies (e.g., a vendor security profile) of an entity (e.g., which may have a digital identity). For example, a basic graph representing a vendor security profile associated with an entity may be built with nodes that may represent attributes, data elements, and/or information fields (e.g., such as the last four digits of a credit card, a social security number, an email address, and/or the like) that may be used to gain access to the entity. The basic graph may include nodes that represent actions for gaining access to the entity, such as accessing an account, changing account data (e.g., such as a default email), and/or the like. The links between the nodes may be defined and/or drawn based on a policy of the entity (e.g., such as a published policy). For example, an online shopping site may allow authentication of a user's identity through the last four digits of a credit card on file. A link may be created (e.g., between providing the last four digits of the credit card and authenticating the user) to represent such as a policy.

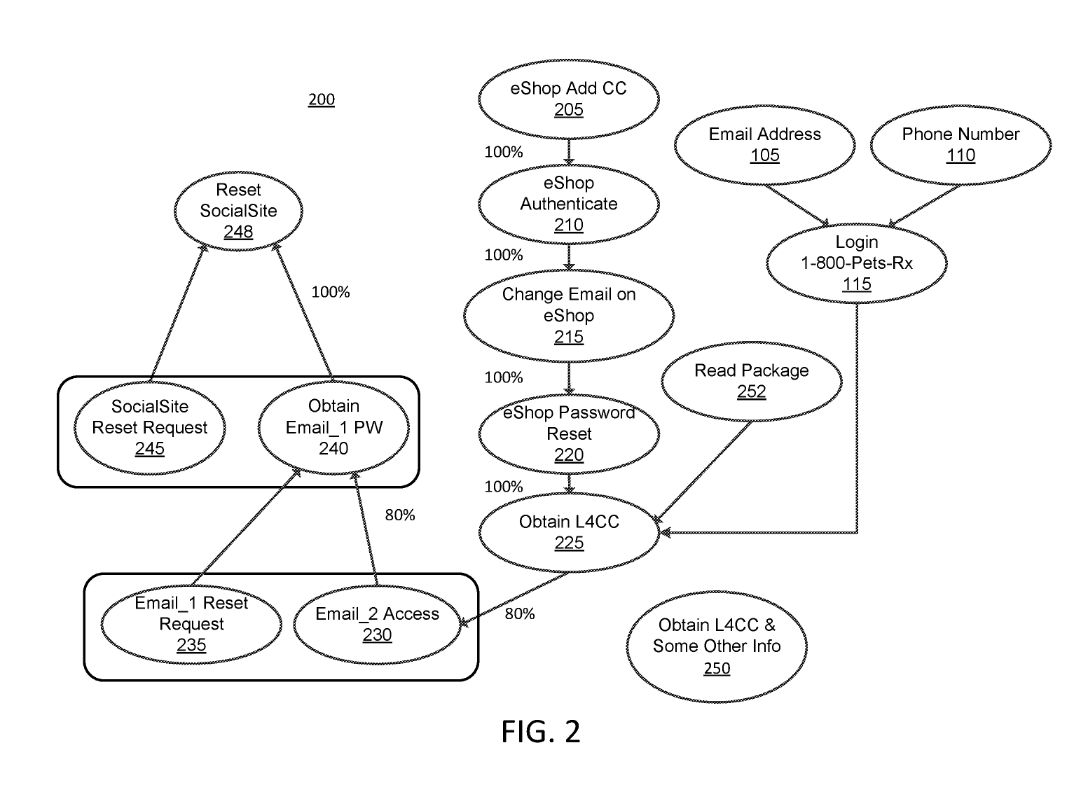

A basic graph may be transformed into an overlay graph. This overlay graph may indicate end to end risks associated with a user experience. For example, an overlay graph 300 as shown in FIG. 3 may be built on an original underlay/basic graph 200 shown in FIG. 2. The overlay graph 300 may include nodes that may be a subset of the nodes in the basic graph 200. One or more links in the overlay graph 300 (e.g., each link in graph 300) may be a path (e.g., which may include several links) in the basic graph 200. Some nodes in the basic graph 200 may represent information (e.g., the last four digits of a credit card) that may be at risk of being in the public. Some nodes may represent actions that may be performed with undesirable security consequences (e.g., obtaining access to an account with the ability to erase information in that account). Such nodes may be linked or combined together as one or more paths. The one or more paths may be turned or converted to a link in the overlay graph.

Vendor and/or user security profiles (e.g., represented by one or more of the graphs described herein) may enable quantified risk assessment and/or numerical rating of privacy protection. For example, the security strength of one or more links (e.g., of each link) in a security profile graph (e.g., a vendor security profile graph or a user security profile graph) may translate into an end to end risk assessment and/or numerical rating. One or more probability numbers may be assigned to indicate the risk that a node of information (e.g., a data element and/or an attribute) may become known in the public, and/or the risk that a link in the original graph may be breached. A higher risk probability and/or a lower numerical rating may indicate greater exposure to security breaches. According to an example, a vendor security profile may take into account a probability that a user may reveal to a customer service representative on the phone a certain credential (e.g., an access value such as a login, a password, a social security number, credit card information, a phone number, etc.) and may be granted a certain access privilege based on the credential revealed. The risk probabilities along a path (e.g., in an overlay graph described herein) may be multiplied to obtain the overall risk assessment for a link (e.g., in the overlay graph). For example, if a risk probability is 20% for one action or data item (e.g., driver's license access) and 30% for another action or data item, the overall probability or risk may be 20%×30%=6%.

Vendor and/or user security profiles (e.g., such as the graphs described herein) may be used to identify weak spots and/or areas for design fortification. Fortification may include, for example, strengthening the security through a redesign, such as adding a procedural step or deleting a link (e.g., from obtaining a driver license number to changing a password). End to end paths with a low numerical rating may be fortified by adding new security requirements (e.g., as part of the recommendations generated for users or entities). When the probability of risk exposure in a link (e.g., in an overlay graph) is substantial enough (e.g., above 80%), a weak spot may be declared and/or determined. A fortification may be designed and/or implemented around the weak spot (e.g., by deleting a link or reducing a link's security risk probability through enactment of a new policy to the customer service department).

According to an example, to access bank account information, security information associated with the user and/or the bank (e.g., an access value such as an associated email address and/or a credit card number on file) may be provided and/or used. A vendor security profile in such an example may be represented by a graph. The graph may include two links, e.g., one from the node representing the bank-account-associated email address and another from the node representing the credit card number, to a node associated with accessing the bank account. The node associated with accessing the bank account may point to and/or be associated with a node representing the bank account. If a user (e.g., who may be a hacker or an unauthorized user instead of the actual or legitimate user) is able to change the email address associated with the given account, for example by providing a social security number, there may be an additional link from the node of social security number to the node of bank-associated-email-address.

The inter-dependence and/or relationship among multiple entities (e.g., multiple online entities) may be defined, provided, and/or visualized using colors, and/or any other suitable identifiers (e.g., in a master user security profile). For example, coloring a node red may indicate that access may be obtained to the information represented by that node in a malicious manner. Coloring a node green may indicate that the information may not be compromised. As such, a security breach into and beyond one node may be represented by red color propagating into other parts of the security profile graph.

Searching for bottleneck nodes, weak links, and long paths may have operational definitions and/or meanings in quantifying the security properties of the system. For example, the service rendered by one service provider (e.g., a bank) may be more important to a user than the service provided by another service provider (e.g., a social media site). As such, a security concern in the more important service may trigger a stronger/faster alert and/or recommendation than a security concern in the less important service (e.g., even if the risk probability of the more important service is lower). Such operational definitions and/or meanings may be subjective to each user. The definitions and/or meanings may be considered in the creation and/or maintenance of a security profile (e.g., a user security profile). Further, with probabilities assigned to the links and nodes in a security profile graph, the risks (e.g., the overall risks) that may be presented or provided to the user may be holistically quantified.

As described herein, graphs (e.g., the basic graph and/or overlay graph) that may be used to visualize and/or define a total security risk may include one or more types of nodes. For example, a node may represent an action (e.g., changing an email account associated with an online account), an outcome (e.g., obtaining the last four digits of a credit card (L4CC)), data or information (e.g., a phone number), a compound action (e.g., sending an account reset request while having access to an associated Email account), and/or the like.

The graph may include a link between two nodes such as a first node A and a second node B. The link may represent and/or define a logical connection between nodes A and B. For example, if moving from node A to node B has a certain probability, the probability may be denoted for and/or associated with the link to provide and/or generate a weighted, directed graph. A basic graph (e.g., an initial graph) may be transformed into an overlay graph as described herein. The overlay graph may indicate the end to end risks associated with an end user experience. A risk assessment may be quantified and/or performed. A privacy protection numerical rating may be generated and/or provided. The security strength of a link may translate into an end to end risk assessment and/or numerical rating. Weak spots in a vendor or user security profile (e.g., in an overlay graph) may be identified, and the design of the vendor or user security profile (e.g., the overlay graph) may be fortified accordingly. For example, end to end paths with a low numerical rating may be fortified by adding new security requirements, as described herein.

An example vendor or user security profile graph (e.g., a total security graph and/or an overlay graph) may include color-coded nodes (e.g., as described herein with red illustrating hacker activity). The graph may show numerical ratings for end-to-end paths, and/or may highlight weak spots. Over a longer timescale (e.g., over months or years), the security graph may be monitored (e.g., continuously monitored). Recommendations and/or suggestions regarding risk exposure may be provided to an end user and/or an entity (e.g., a website). Additional values may be added to products, services, and/or solutions based on the embodiments and/or examples provided herein.

The systems, methods, and instrumentalities described herein may have a variety of applications, including consumer-facing and enterprise-facing implementations as well as implementations for big data systems (e.g., over physical networks and/or virtual relations). For example, implementations of the examples herein may quantify and/or fortify multi-subsystem's total security strength across multiple mobile applications, across multiple social networks, across multiple Enterprise applications (e.g., within a large corporation), across multiple vendors, and/or the like.

FIG. 2 illustrates an example security profile 200 (e.g., a master user security profile) of a multi-subsystem (e.g., including multiple sites or entities) with which a user may be connected. In such a system, information may be compromised among different entities, services, and/or nexuses. A security loophole of the multi-subsystem may be leveraged by attackers as follows. An attacker may add a credit card) to the user's eShop account at 205. Using this new credit card, the attacker may authenticate himself into the user's eShop account at 210. The attacker may change a primary email address on file with the eShop site to an email address that the attacker controls at 215. The attacker may access the eShop website and ask for a password reset at 220. The new password may be sent to the email address that the attacker added at 215. Upon resetting the password (e.g., at 220), the attacker may access the eShop account of the user, and may obtain the Last 4 digits of the user's credit card (L4CC) at 225. The L4CC may be provided to and used by an email service provider (e.g., such as Email_2, with which the user may have registered,) as high-security authentication credential. Once authenticated, the attacker may be able to obtain the user's Email_2 email access (e.g., at least temporarily) at 230, for example by supplying the L4CC over the phone to a customer service representative of Email_2. The user may also provide other information (e.g., at 250) to the email service provider.

The attacker may request a password reset to another email account (e.g., such as Email_1) at 235, for example by asking the password to be sent to the Email_2 address. The new password may be emailed to the user's Email_2 address at 240, by which the attacker may obtain access to the user's Email_1 account. Once the attacker obtains the Email_1 access, the attacker may, at 245, send a reset request to yet another account (e.g., such as a SocialSite account) that may have been set up to communicate with the user using the Email_1 account. As a result, the user's SocialSite account may be comprised by the attacker at 248 (e.g., after the attacker leverages multiple online entities' different security policies to identify the security loophole, as described herein).

One or more security profiles (e.g., including a user security profile and/or a vendor security profile) may be established to depict the path illustrated in FIG. 2 across multiple domains of security subsystems and to reveal the total system's security problems. For example, a critical node in the security subsystems may be the node 225 associated with obtaining the L4CC. The node 225 may be achieved by other paths too, e.g., by reading packages delivered to the user's home at 252 (e.g., if that's feasible for the attacker), or by logging in to 1-800-Pets-Rx as illustrated in association with FIG. 1 (e.g., if the user uses that service). The path involving 1-800-Pets-Rx may in turn require presenting the user's email address and phone number that are often in public domain.

FIG. 3 illustrates an example of an overlay graph 300 that may be converted and/or generated from the graphs of FIGS. 1 and 2. In the example shown in FIG. 3, an end-to-end security loophole may be identified between node 205, which is associated with a first action (e.g., adding a credit card to the eShop account), and node 248, which is associated with a second action (e.g., resetting the SocialSite account), if the victim of the total system's security loophole uses the eShop site. An end-to-end security loophole may also be identified between node 105/110 that is associated with first data elements (e.g., email address and/or phone number) and node 248 that is associated with an action (e.g., resetting SocialSite account), if the victim uses 1-800-Pets-Rx.

The risks described herein may be quantified (e.g., as shown in FIG. 2) by assigning a risk probability to a link that represents moving from a first node to a second node along a path. For example, the actions involved with the eShop operations may have a probability of approximately 100% (which may indicate that it may be likely that the operation will happen and thus the risk may be high) between those nodes. The link from obtaining L4CC to accessing the Email_2 address may involve some uncertainty in how Email_2's help desk may handle the request. As such, that probability may be estimated to be approximately 80% on the link. The next action of obtaining the password for Email_1 (e.g., because the reset link may be sent to the Email_2 address) may also carry a certain amount of uncertainty, which may result in the probability being approximately 80%, for example. By assigning quantified probability values to the nodes and paths of a security profile (e.g., as shown in FIG. 2), an end-to-end path's risk probability (e.g., for an overlay graph as shown in FIG. 3) may be calculated. For example, the end-to-end risk probability of the path leading from node 205 to node 248 in FIG. 2 may be estimated at approximately 64%, by multiplying the probabilities shown in FIG. 2 (e.g., 100%×100%×100%×100%×80%×80%×100%=64%). Such a probability (e.g., 64%) may indicate a high security vulnerability.

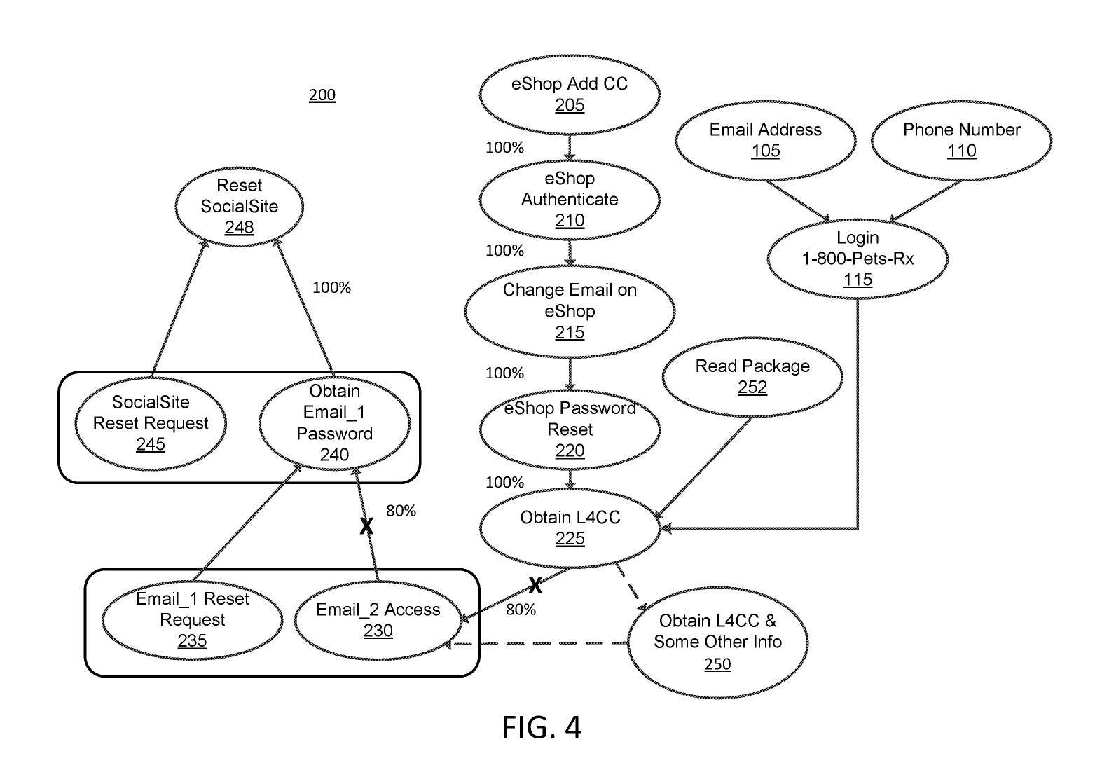

A security system may be re-designed and/or fortified based on an analysis of the corresponding one or more security profiles. FIG. 4 illustrates examples of re-design and/or fortification of a security system. For example, the risk probability of moving from one node to the next may be reduced. In the example shown in FIG. 4, the risk probability between adding a credit card and authenticating a user may be reduced if the help desk of eShop is not allowed to authenticate a user on the phone based on the new credit card information for at least a period of time after the new credit card has been added. Such a measure may reduce the probability of a hacker's success from 100% to, for example, 50%, thereby reducing the overall end-to-end path's risk probability by 50% as well.

A link may be deleted and/or replaced by another link. For example, instead of allowing the link from node 225 (e.g., associated with “Obtain L4CC”) to node 230 (e.g., associated with “Email_2 Access”), the starting node of that link may be replaced with node 250 (e.g., associated with “Obtain L4CC and some other info”), where “some other info” may include other requirements such as answering security questions.

A link may be blocked altogether. For example, the link between node 230 (e.g., associated with “Email_2 Access”) and node 240 (e.g., associated with “Obtain Email_1 Password”) may be eliminated by engineering the Email_1 password reset to use a text message to a mobile phone.

As described herein, a quantitative awareness of a user's risk exposure (e.g., from online presence) may be created (e.g., as shown by the risk probabilities of end-to-end paths) via vendor and/or user security profiles. The security profiles may be monitored (e.g., continuously monitored) such that as different entities (e.g., online companies) change their security policies, vendor security profiles associated with the respective entities and/or a user security profile associated with a user who maintains accounts with the entities may be re-evaluated and/or modified to accommodate the changes. Recommendations and/or warnings may be provided to the user and/or the entities with which the user may interact. For example, the recommendations may include changing a privacy policy, disallowing a dependency, adding a new dependency, and/or the like. The recommendations and/or warnings may be provided in real time (e.g., during an active user session and/or based on differential privacy protection) or over a longer time scale (e.g., via periodic email or text alerts).

For at least long timescale recommendations, artificial digital identities may be created for a user (e.g., for at least some entities with which the user interact). The artificial digital identities may reduce the user's vulnerability to security breaches. The artificial digital identities may be manually generated (e.g., by the user or an online security analyst), or automatically generated by a security system on behalf of the user. For example, one or more artificial digital identities may be generated for the user that may each include a username, a password, and/or basic information such as email contacts. The email contacts may be the same, but the username and the associated password may be different (e.g., through random generations) across the artificial identities. Each of these identities may be stored (e.g., in a database residing on the cloud or on client devices). A mapping of the artificial identities with the user's true identity may be created and maintained.

The artificial digital identities may be used (e.g., automatically used by the system without the user's direction) on behalf of the user. For example, after the digital identities have been created (e.g., via a one-time “generation phase”), the user may login to a website on a recurrent basis. The user may enter her real identity (e.g., through a user interface provided by the website) after entering the target website URL. A software application (e.g., a client side software application) may then open the browser and automatically log in to the website using a randomly selected artificial identity associated with the user's true identity (e.g., by utilizing the mapping relationship described herein). The randomization of digital identities may obfuscate the user's true identity (e.g., make it more difficult for a hacker to guess the user's identify across different online services).

As described herein, accounts may be added to a new or existing user security profile. Security measures/policies may be added to a vendor security profile. The user and/or vendor security profiles may be updated (e.g., by monitoring the security profiles, user activities, and/or policy changes at a corresponding entity). The user and/or vendor security profiles may be stored (e.g., in a repository) and/or used to reveal security/privacy risks.

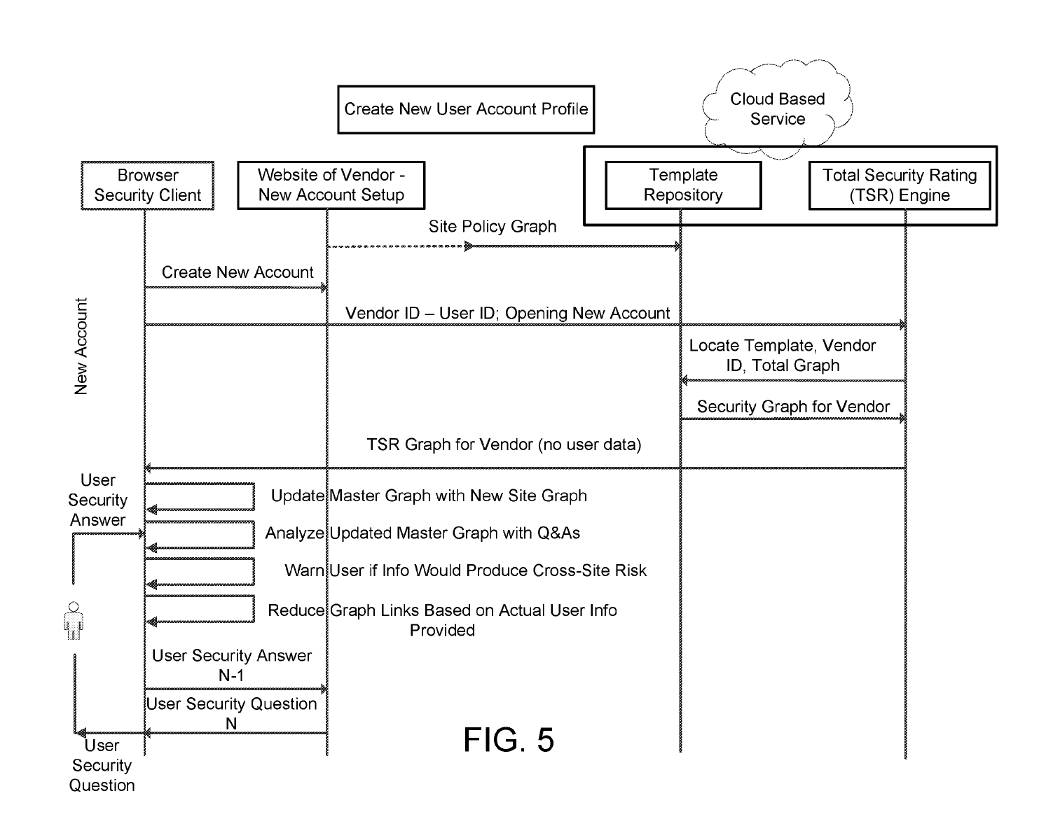

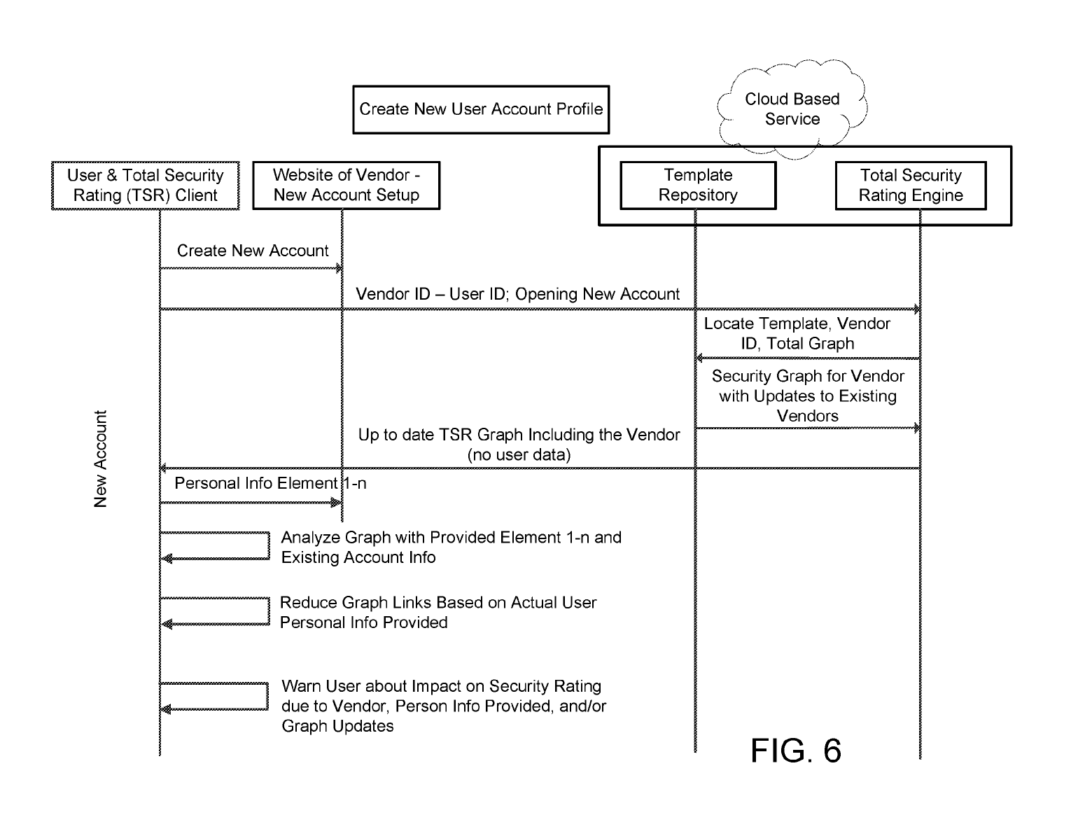

FIGS. 5-6 illustrate examples of adding and/or accessing vendor and user security profiles (e.g., that may be represented by graphs or other types of template, as described herein). The security profiles may include risk probabilities as described herein. The security profiles may be created (e.g., in the form of a graph, a different type of template, etc.), accessed, and/or updated as follows. For example, a user may, from a local computing device (e.g., a personal computer or a mobile device), initiate a new account creation process with a first website (or a first entity or service or nexus). The user may start the new account creation process by choosing from a menu of the most popular online services, for example. The user may start the new account creation process by entering a URL (e.g., through a browser application running on the local computing device) associated with the website, for example. Part of the new account creation process may include providing the user's security information (e.g., including an access value such as a login, a password, an email address, a social security number, a phone number, credit card information, etc.) to the website. The user's activity may be detected, for example, by the local computing device (e.g., via a program running on the computing device). The activity may be reported, for example, to a remote server (e.g., a cloud-based server). The remote server or the local computing device may retrieve (e.g., by providing an ID associated with the first website) and/or receive a vendor security profile (e.g., such as the profile shown in FIG. 1) associated with the first website, a user security profile associated with the user, and/or a vendor security profile associated with another entity with which the user has maintained an account and/or has provided personal security information. Once retrieved, the security profiles may be stored (e.g., temporarily in memory) by the remote server or the local computing device for analysis.

The vendor and/or user security profiles may be built, for example, by a total security rating (TSR) engine (e.g., a cloud-based service) based on information collected from public domain. The information may include, for example, the website's or the entity's security/privacy policies (e.g., what credentials are required for user authentication and/or account updates). The security profiles may be stored in a security profile repository (e.g., the template repository shown in FIGS. 5 and 6). The repository may reside on the remote server (e.g., on the cloud), on the local computing device, and/or on a different computing device (including multiple computing devices). In the case of using cloud, communications among multiple devices may take place in the processes of storing and/or retrieving the security profiles. In the case of using individual devices, consistency update may be performed across the devices (e.g., on a regular basis). The security profiles may take the form of a graph (e.g., a basic graph and/or overlay graph), a list, a set, and/or any other suitable data structure or visualization format.

Different types of data structures (e.g., such as graphs, sets, lists, or more generally collections of relationships) may be used to represent the security profiles (e.g., the vendor security profiles and/or the user security profile). The graphs may use different definitions of nodes and links. For example, the nodes may represent the entities or services involved (online shopping, social media, etc.). The nodes may represent an authentication factor (e.g., the last four digits of a social security number). The nodes may represent an action (e.g., changing phone number for two-factor authentication), and/or the like. The representation or visualization of the security profiles may use non-graph formats such as adjacency lists or bipartite sets. For example, for a security profile with four nodes A-D, node A may point to nodes B and C, node B may point to nodes C and D, node C may point to D. Such a relationship may be represented by an adjacency list, as the following: A: {B, C}, B: {C, D}, C: {D}, D:

The security information that the user is about to provide to the first website may be received by the remote server (e.g., the security information may include at least a security answer and/or credential and/or information) or the local computing device. The one or more vendor security profiles (e.g., graphs for the first website and/or another entity with which the user may have previously registered) retrieved and/or received from the repository may be examined by the remote server (or the local computing device) in relationship to the security information to be submitted and/or the security information previously submitted to the other entity. For example, security information previously provided to the other entity (e.g., another website) may be identified. A determination may be made about whether providing the security information (e.g., the at least one security answer and/or credential and/or information) to the first website may create a security risk to the user (e.g., with respect to the user's access to the current website or to the other entity). If the determination is that providing the security information to the first website may enable an unauthorized person to obtain the user's access to the other entity (e.g., getting access to an eShop account may provide information that may then enable access to Email_2, as described in FIG. 2), or to the information previously provided to the other entity, a warning may be provided (e.g., output and/or displayed on the local computing device) to the user before the security information is sent to the website. If the determination is that providing the security information to the first website may not create a security risk, a confirmation or approval message may be provided to the user.

The warning and/or recommendation (e.g., provided in real time) may be triggered by a differential in the user's security profile before and after the user providing the security information to the website. For example, a first numerical security rating may be determined for the user before the user provides the security information to the website. A second numerical security rating may be determined for the user assuming that the user will provide the security information to the website. The two ratings may be compared to determine whether providing the security information to the website may increase the user's exposure to security risks. If the determination is that the user's risk exposure may increase, a warning and/or recommendation may be provided to alert the user about the risk.

As shown in FIGS. 5 and 6, updates (e.g., adding, removing, and/or changing nodes and/or links) may be made to vendor and/or user security profiles (e.g., including a master user security profile) based on the security formation provided to a new website and/or a new security policy added for the new website. An analysis of the updated security profiles may be conducted such that warning and/or recommendations may be provided the user and/or the relevant entities to strengthen their security practices and/or policies.

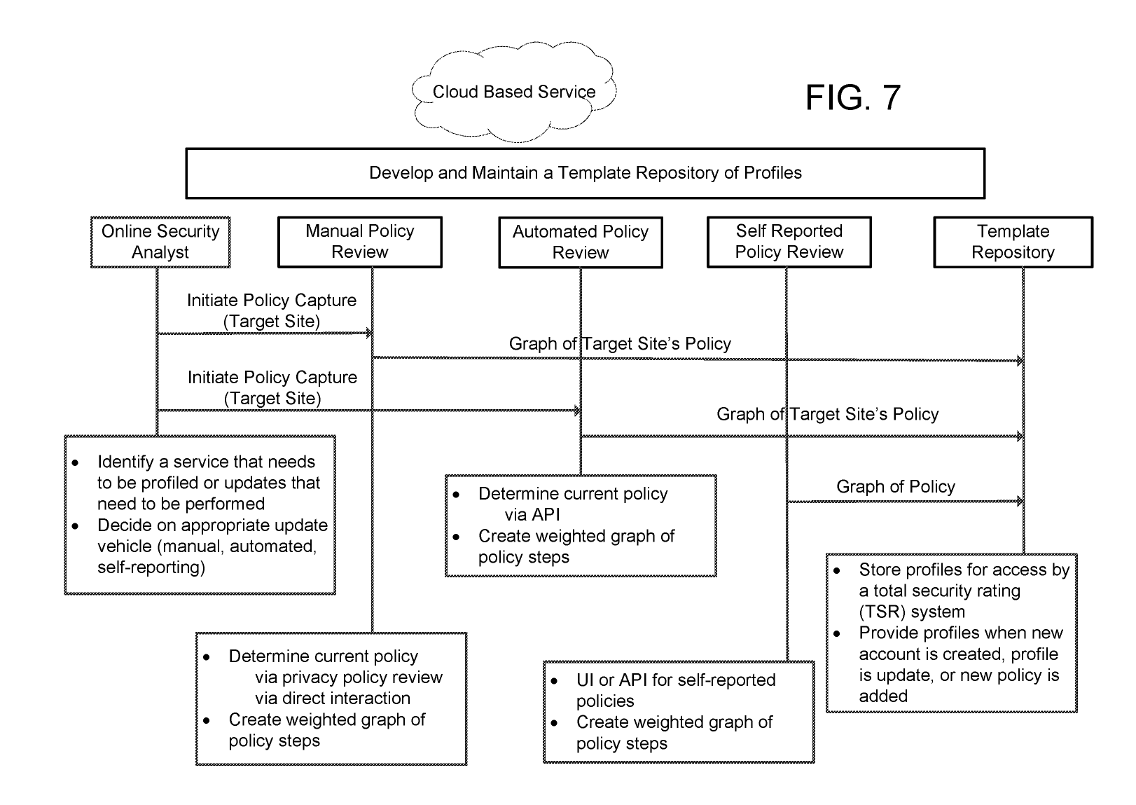

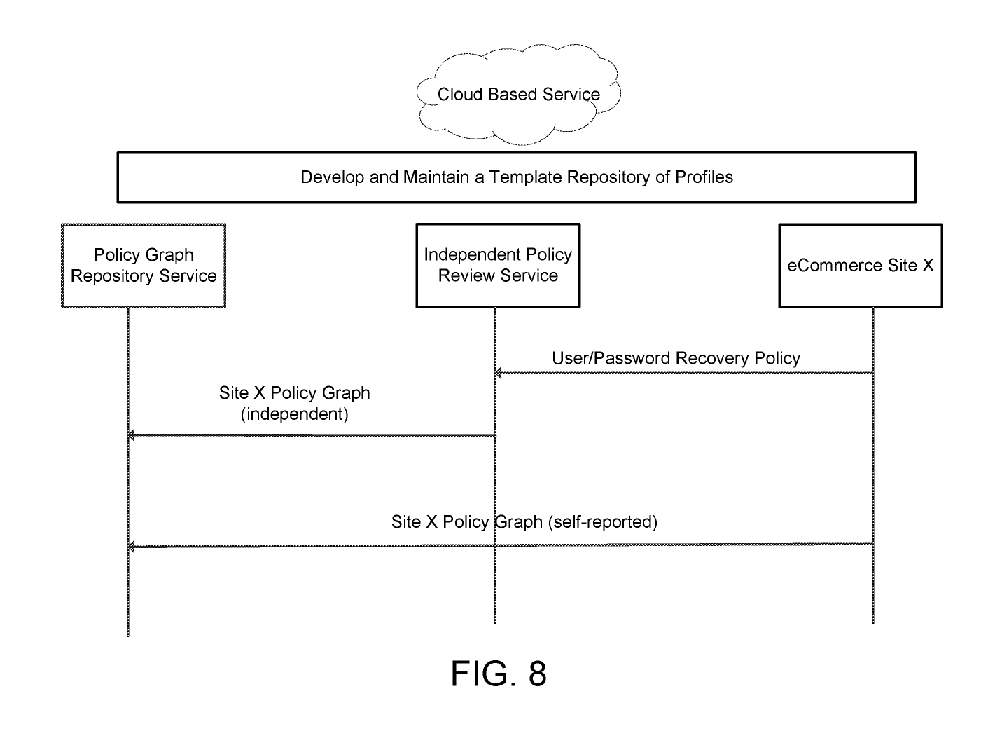

FIGS. 7-8 illustrate examples of providing, developing, and/or maintaining a template repository for storing vendor and/or user security profiles (e.g., such as password/username recovery policy, and/or the like). As shown, a policy and/or vendor security profile capture for a target site may be initiated with manual and/or automated review (e.g., by an online security analyst) or via the target site's self-reporting. For example, the target site's current privacy/security policy (e.g., published privacy policy) may be manually viewed. The policy may be derived via direct interaction (by the online security analyst) with the target site. The policy may be determined automatically (e.g., via an API). The policy may be provided by the target site through self-reporting (e.g., via an UI or API). Once captured, the target site's policy may be summarized/depicted in a vendor security profile (e.g., a basic or overlay graph with weighted nodes and/or links, or a different type of template, etc.), as described herein. The vendor security profile may be provided to and/or stored in a template repository (e.g., as part of and/or to be accessed by a total security rating system). The vendor security profile (e.g., the graph) may be used to assess risks and/or risk probabilities for the target site and/or its associated users. The vendor security profile may be used to provide warnings to a user when new information (e.g., security information) provided by the user may compromise other sites or security information provided to the other sites, as described herein.

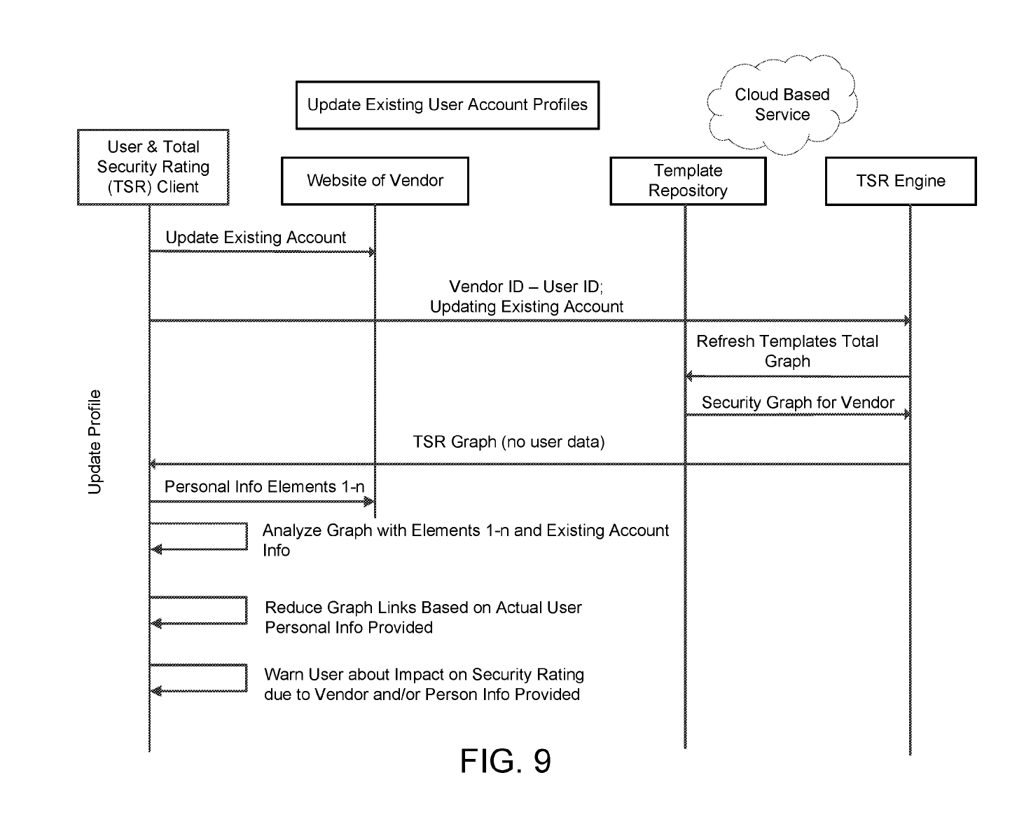

FIG. 9 illustrates an example of updating an existing security profile (e.g., a user security profile). For example, security information elements 1-n (e.g., which may include access values such as new user information, security questions, credentials, and/or the like) may be provided to an entity (e.g., a website) that may already have a vendor security profile (e.g., a vendor security profile graph). The existing vendor security profile may be retrieved and/or received (e.g., by the total security rating engine) from the profile repository based on, for example, an ID associated with the entity. Once retrieved, the vendor security profile may be used to evaluate and/or update the user security profile. For example, the user security profile may be updated (e.g., by the TSR engine or a user device) to reflect the personal information elements 1-n that may be provided to the entity (e.g., a website). During the update, a warning may be provided (e.g., to the user) if such security information elements may compromise another entity (e.g., because the user maintains accounts with the other entity or has provided personal information to the other entity).

As described herein, systems, methods, and instrumentalities for creating or enabling the creation of vendor and/or user security profiles may be provided. The vendor and/or user security profiles may be created using a template (e.g., in the form of a structured graph). Online and/or offline services, client account sensitive information, and/or the like may be stored and used for determining a user's rights to access an account or change its properties (e.g., such as password reset). If the security profiles are represented in the form of graphs, nodes of the graphs may represent user private data elements, actions, outcome, or a combination of these, as described herein and shown in FIG. 1-4, for example. Links of the graphs may capture the logical connections between data elements (e.g., nodes) within the respective graphs. The links may be used to verify the identity of a user and/or the user's rights in changing or accessing private information. The links may be assigned a weighted rating (e.g., a risk probability) based on the likelihood of access rights being granted in accordance with the hard or soft policies of a particular service or business. The vendor and/or user security profiles may be stored in a repository indexed by service, enterprise, web URL, a user identifier, and/or the like. The stored profiles may be retrieved, for example, when a user accesses a new or existing account to build and/or maintain a custom total security rating profile (e.g., one or more graphs associated with multiple accounts of the user).

Vendor and/or user security profiles may be monitored (e.g., continuously monitor), for example, by a centralized system or a local device. The vendor and/or user security profiles (e.g., which may be represented as graphs and/or may include total security rating) may be created and/or updated based on templates from a repository, data that the user provides, etc. The vendor and/or user security profiles may be interconnected in a manner determined by, for example, the templates or active user sessions (e.g., user sessions that are in more frequent use). The vendor and/or user security profiles may include links identifying connections of nodes (e.g., a node yielding information that allows access to the next node). Real-time analysis of an updated security profile (e.g., a vendor security profile or a user security profile) may be provided to determine the sensitivity of the information being requested and/or shared. A quantified vendor and/or user security profile may be created that highlights potential risks to privacy breaches. A graph representing a vendor or user security profile may be transformed. Real-time recommendations as to specific weaknesses in a security profile may be provided with suggestions on how to improve the user's or vendor's security posture. The suggestions may include, for example, eliminating particular user accounts, obfuscating certain identifiable information (e.g., provide a vendor alternate credit card numbers, or inaccurate information), and/or the like.

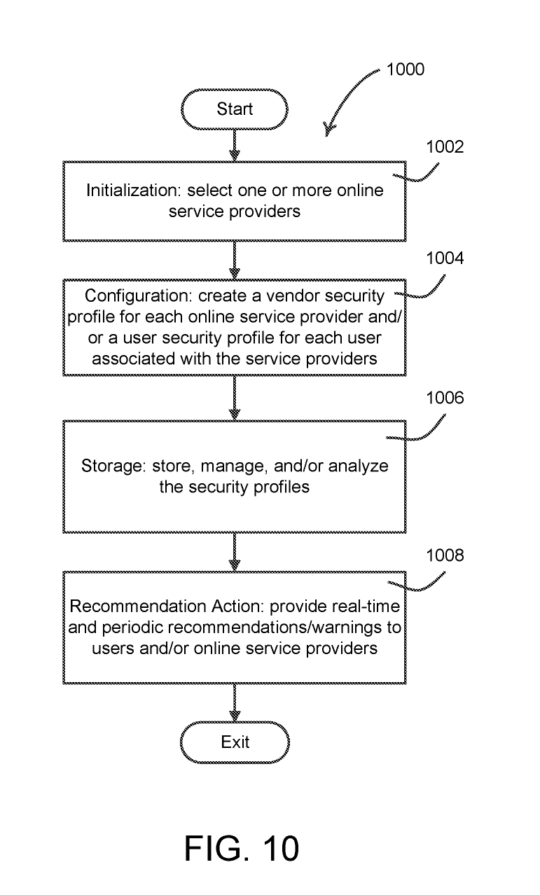

FIG. 10 depicts an example procedure 1000 for setting up and operating a security system or service as described herein. Initialization may take place at 1002, when a user may select an entity (e.g., an online service provider) to which the user may provide security information. For example, the user may select the entity by choosing from a menu of the most popular online services (e.g., without submitting security information such as a passcode). The user may access the menu, for example by visiting a website, or through an application installed and running on a device associated with the user. Configuration may be performed once the entity has been selected. A vendor security profile may be created and/or configured, at 1004, for the entity. The vendor security profile may be created, for example by a total security rating (TSR) engine (e.g., a cloud-based service) or by the user device. The creation of the vendor security profile may be based on information collected from public domain (e.g., which may be stored in a database). The information may include, for example, the entity's security/privacy policies (e.g., what credentials are required for user authentication and/or for account updates). Storage and/or management of the security profiles may occur at 1006. For example, once created, the vendor security profile may be stored, at 1006, in a security profile repository (e.g., the template repository shown in FIGS. 5 and 6). The repository may reside on a remote server (e.g., on the cloud) or on a local computing device (including multiple local computing devices). In the case of using cloud, communications among multiple devices may take place in the processes of storing and/or retrieving the security profiles. In the case of using local devices (e.g., individual devices), consistency update may be performed across the local devices (e.g., on a regular basis). The stored vendor security profile may be managed (e.g., updated upon detecting policy changes at the entity) and/or analyzed (e.g., to compute or derive recommendations for the user or the entity). Recommendation actions may be performed at 1008. Recommendations and/or warnings may be provided to the user and/or the entity. The recommendations and/or warnings may be provided in real-time (e.g., upon determining that the user is in the process of providing security information to the entity or to a different entity). The recommendations and/or warnings may be provided over a long timescale (e.g., through periodic alerts or suggestions). In either or both cases, the recommendations and/or warnings may be presented to the user via a user interface (e.g., a display on a user device) and/or through email/text alerts.

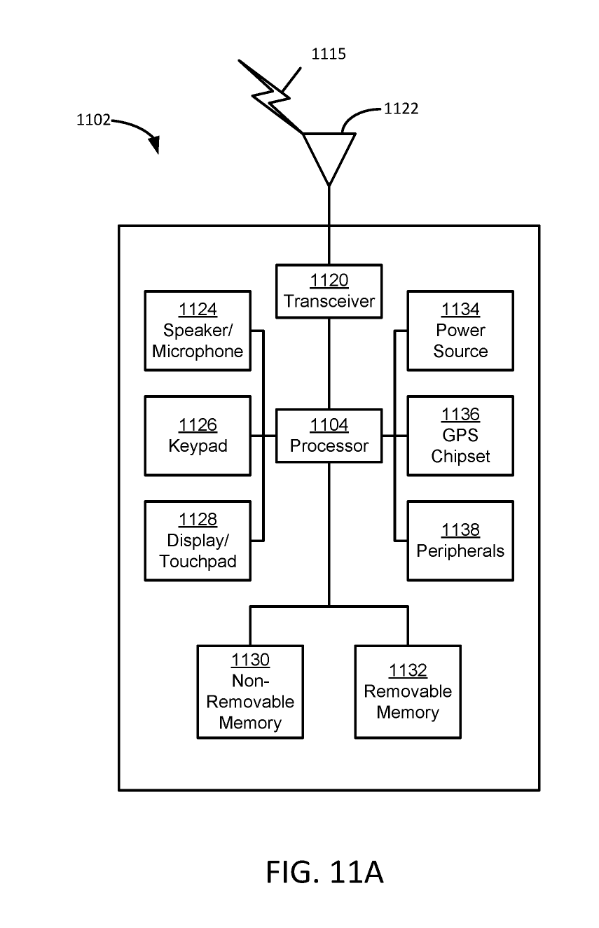

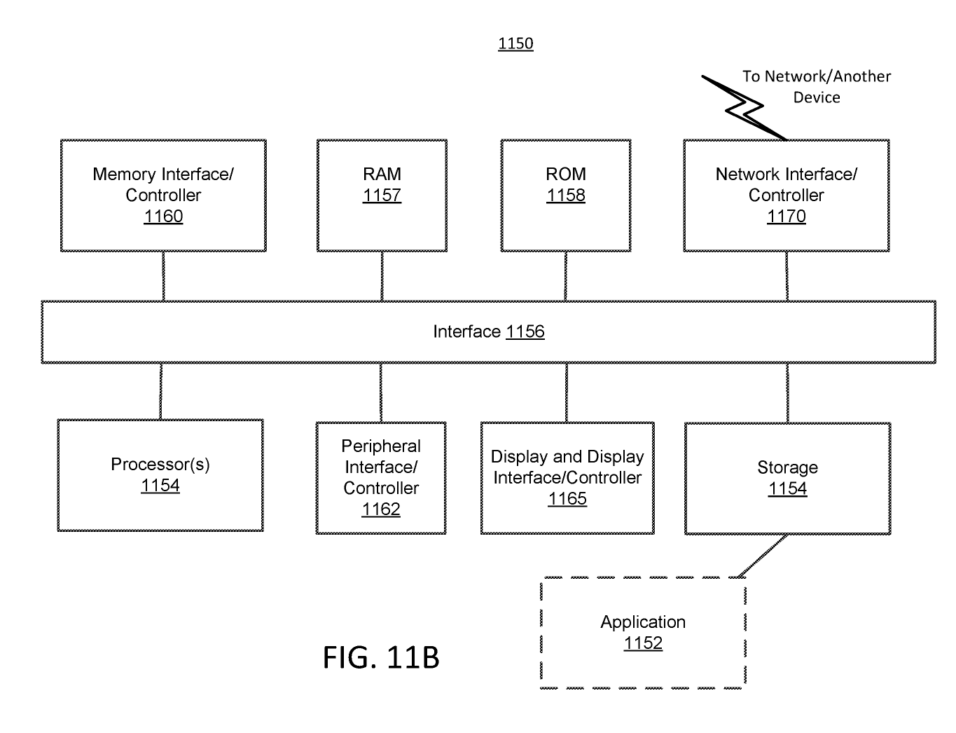

FIG. 11A depicts an example system diagram of one or more components or additional components that may be included in a device 1102 such as a mobile device, a tablet, a server, a system, a repository, and/or the like to implement the examples as described herein. As shown in FIG. 11A, the components of the device may include a processor 1118, a transceiver 1120, a transmit/receive element 1122, a speaker/microphone 1124, a keypad 1126, a display/touchpad component or interface 1128, non-removable memory 1130, removable memory 1132, a power source 1134, a global positioning system (GPS) chipset 1136, and other peripherals 1138. It may be appreciated that the device may include any sub-combination of the foregoing elements while remaining consistent with an embodiment. Also, embodiments contemplate that other devices and/or servers or systems described herein, may include some or all of the elements depicted in FIG. 11A and described herein.

The processor 1118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1118 may perform signal coding, data processing, power control, input/output processing, and/or any other functionality that may enable the device to operate in a wireless environment. The processor 1118 may be coupled to the transceiver 1120, which may be coupled to the transmit/receive element 1122. While FIG. 11A depicts the processor 1118 and the transceiver 1120 as separate components, it may be appreciated that the processor 1118 and the transceiver 1120 may be integrated together in an electronic package or chip.

The transmit/receive element 1122 may be configured to transmit signals to, or receive signals from, another device (e.g., the user's device and/or a network component such as a base station, access point, or other component in a wireless network) over an air interface 1115. For example, in one embodiment, the transmit/receive element 1122 may be an antenna configured to transmit and/or receive RF signals. In another or additional embodiment, the transmit/receive element 1122 may be an emitter/detector configured to transmit and/or receive IR, UV, or visible light signals, for example. In yet another or additional embodiment, the transmit/receive element 1122 may be configured to transmit and receive both RF and light signals. It may be appreciated that the transmit/receive element 1122 may be configured to transmit and/or receive any combination of wireless signals (e.g., Bluetooth, WiFi, and/or the like).

In addition, although the transmit/receive element 1122 is depicted in FIG. 11A as a single element, the device may include any number of transmit/receive elements 1122. More specifically, the device may employ MIMO technology. Thus, in one embodiment, the device may include two or more transmit/receive elements 1122 (e.g., multiple antennas) for transmitting and receiving wireless signals over the air interface 1115.

The transceiver 1120 may be configured to modulate the signals that are to be transmitted by the transmit/receive element 1122 and to demodulate the signals that are received by the transmit/receive element 1122. As noted above, the device may have multi-mode capabilities. Thus, the transceiver 1120 may include multiple transceivers for enabling the device to communicate via multiple RATs, such as UTRA and IEEE 802.11, for example.

The processor 1118 of the device may be coupled to, and may receive user input data from, the speaker/microphone 1124, the keypad or touch interface 1126, and/or the display/touchpad 1128 (e.g., a liquid crystal display (LCD) display unit or organic light-emitting diode (OLED) display unit). The processor 1118 may also output user data to the speaker/microphone 1124, the keypad 1126, and/or the display/touchpad 1128. In addition, the processor 1118 may access information from, and store data in, any type of suitable memory, such as the non-removable memory 1130 and/or the removable memory 1132. The non-removable memory 1130 may include random-access memory (RAM), read-only memory (ROM), a hard disk, or any other type of memory storage device. The removable memory 1132 may include a subscriber identity module (SIM) card, a memory stick, a secure digital (SD) memory card, and the like. In other embodiments, the processor 1118 may access information from, and store data in, memory that is not physically located on the device, such as on a server or a home computer (not shown). The removable memory 1130 and/or non-removable memory 1132 may store a user profile or other information associated therewith that may be used as described herein.

The processor 1118 may receive power from the power source 1134, and may be configured to distribute and/or control the power to the other components in the device. The power source 1134 may be any suitable device for powering the device. For example, the power source 1134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1118 may also be coupled to the GPS chipset 1136, which may be configured to provide location information (e.g., longitude and latitude) regarding the current location of the device. In addition to, or in lieu of, the information from the GPS chipset 1136, the device may receive location information over the air interface 1115 from another device or network component and/or determine its location based on the timing of the signals being received from two or more nearby network components. It may be appreciated that the device may acquire location information by way of any suitable location-determination method while remaining consistent with an embodiment.

The processor 1118 may further be coupled to other peripherals 1138, which may include one or more software and/or hardware modules that provide additional features, functionality and/or wired or wireless connectivity. For example, the peripherals 1138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 11B depicts a block diagram of one or more components or additional components that may be included in a device 1150 such as a mobile device, a tablet, a server, a system, a repository, and/or the like to implement the examples as described herein. The components of the device may be capable of executing a variety of computing applications 1152. The computing applications 1152 may be stored in a storage component 1115 (and/or RAM or ROM described herein). The computing application 1152 may include a computing application, a computing applet, a computing program and other instruction set operative on the computing device 1150 to perform at least one function, operation, and/or procedure as described herein. According to an example, the computing applications may include the methods and/or applications described herein. The device may be controlled primarily by computer readable instructions that may be in the form of software. The computer readable instructions may include instructions for the device for storing and accessing the computer readable instructions themselves. Such software may be executed within a processor 1154 such as a central processing unit (CPU) and/or other processors such as a co-processor to cause the device to perform the processes or functions associated therewith. The processor 1154 may be implemented by micro-electronic chips CPUs called microprocessors.

In operation, the processor 1154 may fetch, decode, and/or execute instructions and may transfer information to and from other resources via an interface 1156 such as a main data-transfer path or a system bus. Such an interface or system bus may connect the components in the device and may define the medium for data exchange. The device may further include memory devices coupled to the interface 1156. According to an example embodiment, the memory devices may include a random access memory (RAM) 1157 and read only memory (ROM) 1158. The RAM 1157 and ROM 1158 may include circuitry that allows information to be stored and retrieved. In one embodiment, the ROM 1158 may include stored data that cannot be modified. Additionally, data stored in the RAM 1157 typically may be read or changed by the processor 1154 or other hardware devices. Access to the RAM 1157 and/or ROM 1158 may be controlled by a memory controller 1160. The memory controller 1160 may provide an address translation function that translates virtual addresses into physical addresses as instructions are executed.

In addition, the may include a peripherals controller 1162 that may be responsible for communicating instructions from the processor 1154 to peripherals such as a printer, a keypad or keyboard, a mouse, and a storage component. The device may further include a display controller 1165. The display/display controller 1165 may be used to display visual output generated by the device. Such visual output may include text, graphics, animated graphics, video, or the like. The display controller associated with the display (e.g., shown in combination as 1165 but may be separate components) may include electronic components that generate a video signal that may be sent to the display. Further, the device may include a network interface or controller 1170 (e.g., a network adapter) that may be used to connect the device to an external communication network and/or other devices (not shown).

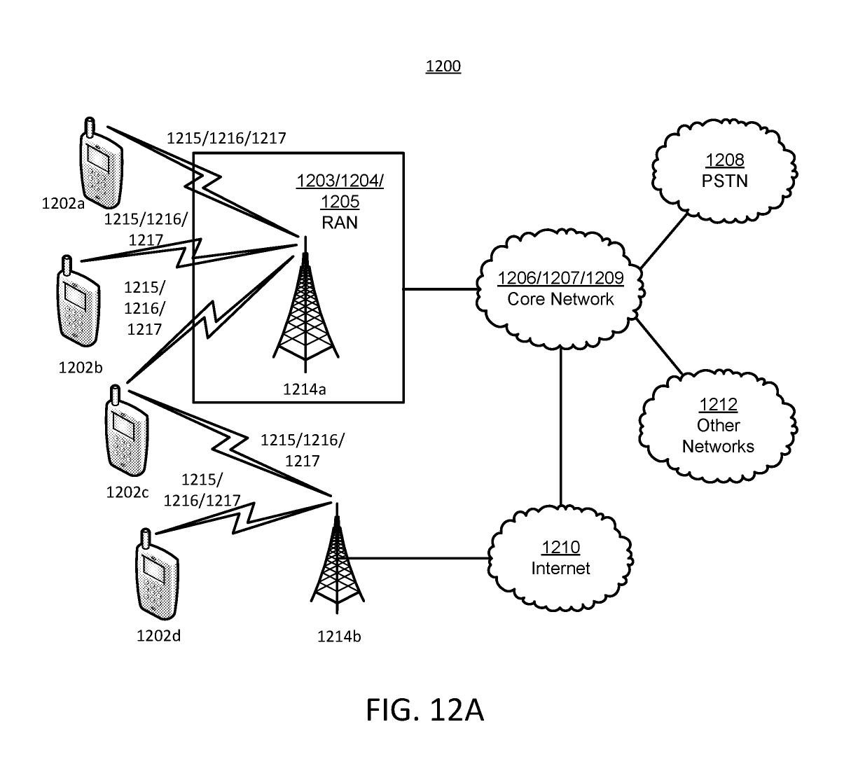

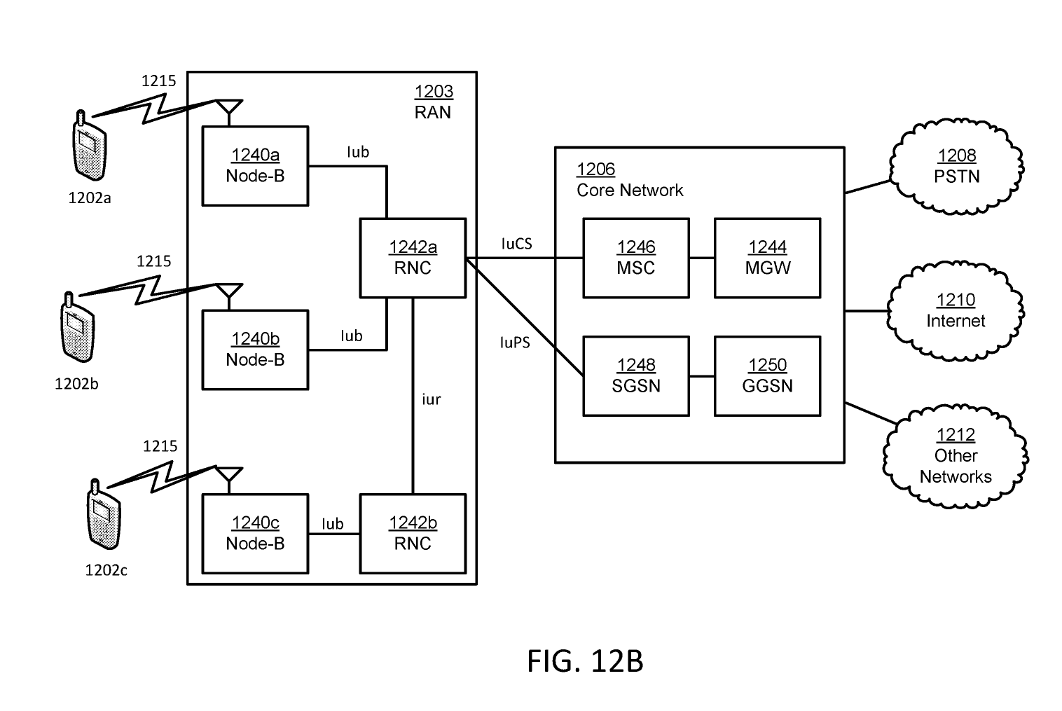

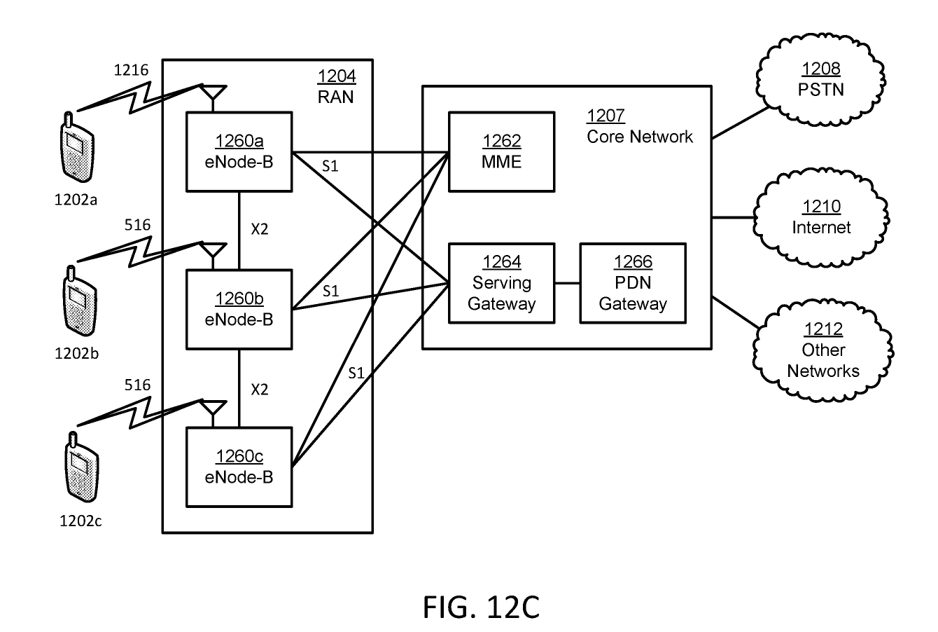

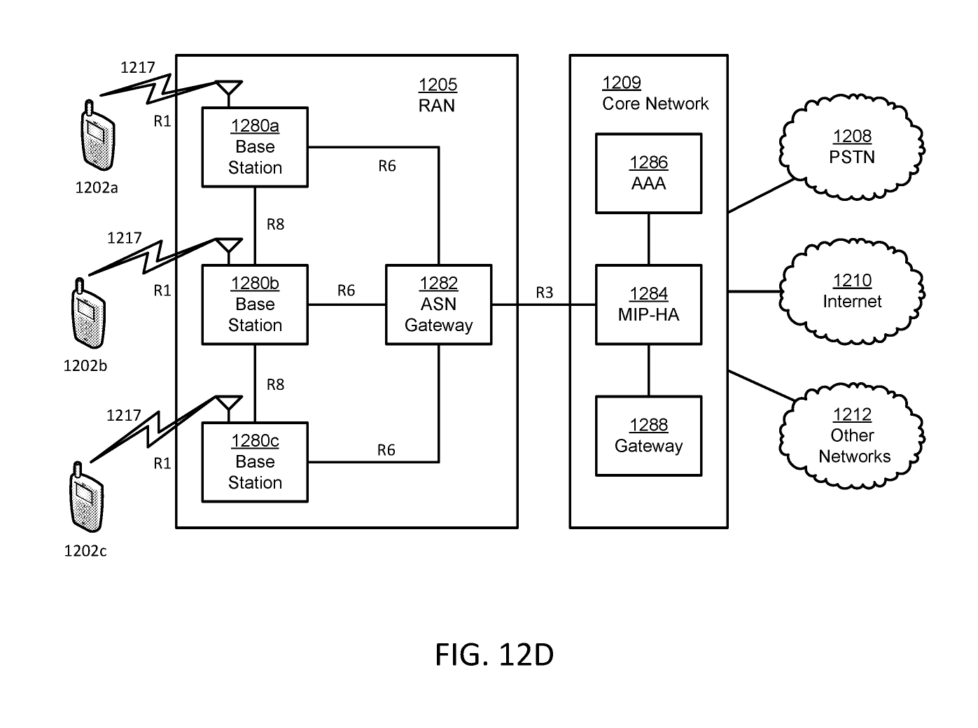

FIG. 12A depicts a diagram of an example communications system 1200 in which one or more disclosed embodiments may be implemented and/or may be used. The communications system 1200 may be a multiple access system that provides content, such as voice, data, video, messaging, broadcast, etc., to multiple wireless users. The communications system 1200 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 12A, the communications system 1200 may include wireless transmit/receive units (WTRUs) 1202a, 1202b, 1202c, and/or 1202d (which generally or collectively may be referred to as WTRU 1202), a radio access network (RAN) 1203/1204/1205, a core network 1206/1207/1209, a public switched telephone network (PSTN) 1208, the Internet 1210, and other networks 1212, though it will be appreciated that the disclosed embodiments contemplate any number of WTRUs, base stations, networks, and/or network elements. Each of the WTRUs 1202a, 1202b, 1202c, and/or 1202d may be any type of device configured to operate and/or communicate in a wireless environment. By way of example, the WTRUs 1202a, 1202b, 1202c, and/or 1202d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 1200 may also include a base station 1214a and a base station 1214b. Each of the base stations 1214a, 1214b may be any type of device configured to wirelessly interface with at least one of the WTRUs 1202a, 1202b, 1202c, and/or 1202d to facilitate access to one or more communication networks, such as the core network 1206/1207/1209, the Internet 1210, and/or the networks 1212. By way of example, the base stations 1214a and/or 1214b may be a base transceiver station (BTS), a Node-B, an eNode B, a Home Node B, a Home eNode B, a site controller, an access point (AP), a wireless router, and the like. While the base stations 1214a, 1214b are each depicted as a single element, it will be appreciated that the base stations 1214a, 1214b may include any number of interconnected base stations and/or network elements.

The base station 1214a may be part of the RAN 1203/1204/1205, which may also include other base stations and/or network elements (not shown), such as a base station controller (BSC), a radio network controller (RNC), relay nodes, etc. The base station 1214a and/or the base station 1214b may be configured to transmit and/or receive wireless signals within a particular geographic region, which may be referred to as a cell (not shown). The cell may further be divided into cell sectors. For example, the cell associated with the base station 1214a may be divided into three sectors. Thus, in one embodiment, the base station 1214a may include three transceivers, i.e., one for each sector of the cell. In another embodiment, the base station 1214a may employ multiple-input multiple output (MIMO) technology and, therefore, may utilize multiple transceivers for each sector of the cell.

The base stations 1214a and/or 1214b may communicate with one or more of the WTRUs 1202a, 1202b, 1202c, and/or 1202d over an air interface 1215/1216/1217, which may be any suitable wireless communication link (e.g., radio frequency (RF), microwave, infrared (IR), ultraviolet (UV), visible light, etc.). The air interface 1215/1216/1217 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 1214a in the RAN 1203/1204/1205 and the WTRUs 1202a, 1202b, and/or 1202c may implement a radio technology such as Universal Mobile Telecommunications System (UMTS) Terrestrial Radio Access (UTRA), which may establish the air interface 1215/1216/1217 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 1214a and the WTRUs 1202a, 1202b, and/or 1202c may implement a radio technology such as Evolved UMTS Terrestrial Radio Access (E-UTRA), which may establish the air interface 1215/1216/1217 using Long Term Evolution (LTE) and/or LTE-Advanced (LTE-A).

In other embodiments, the base station 1214a and the WTRUs 1202a, 1202b, and/or 1202c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 1214b in FIG. 12A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 1214b and the WTRUs 1202c, 1202d may implement a radio technology such as IEEE 802.11 to establish a wireless local area network (WLAN). In another embodiment, the base station 1214b and the WTRUs 1202c, 1202d may implement a radio technology such as IEEE 802.15 to establish a wireless personal area network (WPAN). In yet another embodiment, the base station 1214b and the WTRUs 1202c, 1202d may utilize a cellular-based RAT (e.g., WCDMA, CDMA2000, GSM, LTE, LTE-A, etc.) to establish a picocell or femtocell. As shown in FIG. 12A, the base station 1214b may have a direct connection to the Internet 1210. Thus, the base station 1214b may not be required to access the Internet 1210 via the core network 1206/1207/1209.

The RAN 1203/1204/1205 may be in communication with the core network 1206/1207/1209, which may be any type of network configured to provide voice, data, applications, and/or voice over internet protocol (VoIP) services to one or more of the WTRUs 1202a, 1202b, 1202c, and/or 1202d. For example, the core network 1206/1207/1209 may provide call control, billing services, mobile location-based services, pre-paid calling, Internet connectivity, video distribution, etc., and/or perform high-level security functions, such as user authentication. Although not shown in FIG. 12A, it will be appreciated that the RAN 1203/1204/1205 and/or the core network 1206/1207/1209 may be in direct or indirect communication with other RANs that employ the same RAT as the RAN 1203/1204/1205 or a different RAT. For example, in addition to being connected to the RAN 1203/1204/1205, which may be utilizing an E-UTRA radio technology, the core network 1206/1207/1209 may also be in communication with another RAN (not shown) employing a GSM radio technology.

The core network 1206/1207/1209 may also serve as a gateway for the WTRUs 1202a, 1202b, 1202c, and/or 1202d to access the PSTN 1208, the Internet 1210, and/or other networks 1212. The PSTN 1208 may include circuit-switched telephone networks that provide plain old telephone service (POTS). The Internet 1210 may include a global system of interconnected computer networks and devices that use common communication protocols, such as the transmission control protocol (TCP), user datagram protocol (UDP) and the internet protocol (IP) in the TCP/IP internet protocol suite. The networks 1212 may include wired or wireless communications networks owned and/or operated by other service providers. For example, the networks 1212 may include another core network connected to one or more RANs, which may employ the same RAT as the RAN 1203/1204/1205 or a different RAT.

Some or all of the WTRUs 1202a, 1202b, 1202c, and/or 1202d in the communications system 1200 may include multi-mode capabilities, i.e., the WTRUs 1202a, 1202b, 1202c, and/or 1202d may include multiple transceivers for communicating with different wireless networks over different wireless links. For example, the WTRU 1202c shown in FIG. 12A may be configured to communicate with the base station 1214a, which may employ a cellular-based radio technology, and with the base station 1214b, which may employ an IEEE 802 radio technology.

FIG. 12B depicts a system diagram of the RAN 1203 and the core network 1206 according to an embodiment. As noted above, the RAN 1203 may employ a UTRA radio technology to communicate with the WTRUs 1202a, 1202b, and/or 1202c over the air interface 1215. The RAN 1203 may also be in communication with the core network 1206. As shown in FIG. 12B, the RAN 1203 may include Node-Bs 1240a, 1240b, and/or 1240c, which may each include one or more transceivers for communicating with the WTRUs 1202a, 1202b, and/or 1202c over the air interface 1215. The Node-Bs 1240a, 1240b, and/or 1240c may each be associated with a particular cell (not shown) within the RAN 1203. The RAN 1203 may also include RNCs 1242a and/or 1242b. It will be appreciated that the RAN 1203 may include any number of Node-Bs and RNCs while remaining consistent with an embodiment.

As shown in FIG. 12B, the Node-Bs 1240a and/or 1240b may be in communication with the RNC 1242a. Additionally, the Node-B 1240c may be in communication with the RNC 1242b. The Node-Bs 1240a, 1240b, and/or 1240c may communicate with the respective RNCs 1242a, 1242b via an Iub interface. The RNCs 1242a, 1242b may be in communication with one another via an Iur interface. Each of the RNCs 1242a, 1242b may be configured to control the respective Node-Bs 1240a, 1240b, and/or 1240c to which it is connected. In addition, each of the RNCs 1242a, 1242b may be configured to carry out or support other functionality, such as outer loop power control, load control, admission control, packet scheduling, handover control, macrodiversity, security functions, data encryption, and the like.

The core network 1206 shown in FIG. 12B may include a media gateway (MGW) 1244, a mobile switching center (MSC) 1246, a serving GPRS support node (SGSN) 1248, and/or a gateway GPRS support node (GGSN) 1250. While each of the foregoing elements are depicted as part of the core network 1206, it will be appreciated that any one of these elements may be owned and/or operated by an entity other than the core network operator.

The RNC 1242a in the RAN 1203 may be connected to the MSC 1246 in the core network 1206 via an IuCS interface. The MSC 1246 may be connected to the MGW 1244. The MSC 1246 and the MGW 1244 may provide the WTRUs 1202a, 1202b, and/or 1202c with access to circuit-switched networks, such as the PSTN 1208, to facilitate communications between the WTRUs 1202a, 1202b, and/or 1202c and traditional land-line communications devices.

The RNC 1242a in the RAN 1203 may also be connected to the SGSN 1248 in the core network 1206 via an IuPS interface. The SGSN 1248 may be connected to the GGSN 1250. The SGSN 1248 and the GGSN 1250 may provide the WTRUs 1202a, 1202b, and/or 1202c with access to packet-switched networks, such as the Internet 1210, to facilitate communications between and the WTRUs 1202a, 1202b, and/or 1202c and IP-enabled devices.

As noted above, the core network 1206 may also be connected to the networks 1212, which may include other wired or wireless networks that are owned and/or operated by other service providers.

FIG. 12C depicts a system diagram of the RAN 1204 and the core network 1207 according to an embodiment. As noted above, the RAN 1204 may employ an E-UTRA radio technology to communicate with the WTRUs 1202a, 1202b, and/or 1202c over the air interface 1216. The RAN 1204 may also be in communication with the core network 1207.

The RAN 1204 may include eNode-Bs 1260a, 1260b, and/or 1260c, though it will be appreciated that the RAN 1204 may include any number of eNode-Bs while remaining consistent with an embodiment. The eNode-Bs 1260a, 1260b, and/or 1260c may each include one or more transceivers for communicating with the WTRUs 1202a, 1202b, and/or 1202c over the air interface 1216. In one embodiment, the eNode-Bs 1260a, 1260b, and/or 1260c may implement MIMO technology. Thus, the eNode-B 1260a, for example, may use multiple antennas to transmit wireless signals to, and receive wireless signals from, the WTRU 1202a.

Each of the eNode-Bs 1260a, 1260b, and/or 1260c may be associated with a particular cell (not shown) and may be configured to handle radio resource management decisions, handover decisions, scheduling of users in the uplink and/or downlink, and the like. As shown in FIG. 12C, the eNode-Bs 1260a, 1260b, and/or 1260c may communicate with one another over an X2 interface.

The core network 1207 shown in FIG. 12C may include a mobility management gateway (MME) 1262, a serving gateway 1264, and a packet data network (PDN) gateway 1266. While each of the foregoing elements are depicted as part of the core network 1207, it will be appreciated that any one of these elements may be owned and/or operated by an entity other than the core network operator.

The MME 1262 may be connected to each of the eNode-Bs 1260a, 1260b, and/or 1260c in the RAN 1204 via an Si interface and may serve as a control node. For example, the MME 1262 may be responsible for authenticating users of the WTRUs 1202a, 1202b, and/or 1202c, bearer activation/deactivation, selecting a particular serving gateway during an initial attach of the WTRUs 1202a, 1202b, and/or 1202c, and the like. The MME 1262 may also provide a control plane function for switching between the RAN 1204 and other RANs (not shown) that employ other radio technologies, such as GSM or WCDMA.

The serving gateway 1264 may be connected to each of the eNode-Bs 1260a, 1260b, and/or 1260c in the RAN 1204 via the Si interface. The serving gateway 1264 may generally route and forward user data packets to/from the WTRUs 1202a, 1202b, and/or 1202c. The serving gateway 1264 may also perform other functions, such as anchoring user planes during inter-eNode B handovers, triggering paging when downlink data is available for the WTRUs 1202a, 1202b, and/or 1202c, managing and storing contexts of the WTRUs 1202a, 1202b, and/or 1202c, and the like.

The serving gateway 1264 may also be connected to the PDN gateway 1266, which may provide the WTRUs 1202a, 1202b, and/or 1202c with access to packet-switched networks, such as the Internet 1210, to facilitate communications between the WTRUs 1202a, 1202b, and/or 1202c and IP-enabled devices.

The core network 1207 may facilitate communications with other networks. For example, the core network 1207 may provide the WTRUs 1202a, 1202b, and/or 1202c with access to circuit-switched networks, such as the PSTN 1208, to facilitate communications between the WTRUs 1202a, 1202b, and/or 1202c and traditional land-line communications devices. For example, the core network 1207 may include, or may communicate with, an IP gateway (e.g., an IP multimedia subsystem (IMS) server) that serves as an interface between the core network 1207 and the PSTN 1208. In addition, the core network 1207 may provide the WTRUs 1202a, 1202b, and/or 1202c with access to the networks 1212, which may include other wired or wireless networks that are owned and/or operated by other service providers.

FIG. 12D depicts a system diagram of the RAN 1205 and the core network 1209 according to an embodiment. The RAN 1205 may be an access service network (ASN) that employs IEEE 802.16 radio technology to communicate with the WTRUs 1202a, 1202b, and/or 1202c over the air interface 1217. As will be further discussed below, the communication links between the different functional entities of the WTRUs 1202a, 1202b, and/or 1202c, the RAN 1205, and the core network 1209 may be defined as reference points.

As shown in FIG. 12D, the RAN 1205 may include base stations 1280a, 1280b, and/or 1280c, and an ASN gateway 1282, though it will be appreciated that the RAN 1205 may include any number of base stations and ASN gateways while remaining consistent with an embodiment. The base stations 1280a, 1280b, and/or 1280c may each be associated with a particular cell (not shown) in the RAN 1205 and may each include one or more transceivers for communicating with the WTRUs 1202a, 1202b, and/or 1202c over the air interface 1217. In one embodiment, the base stations 1280a, 1280b, and/or 1280c may implement MIMO technology. Thus, the base station 1280a, for example, may use multiple antennas to transmit wireless signals to, and receive wireless signals from, the WTRU 1202a. The base stations 1280a, 1280b, and/or 1280c may also provide mobility management functions, such as handoff triggering, tunnel establishment, radio resource management, traffic classification, quality of service (QoS) policy enforcement, and the like. The ASN gateway 1282 may serve as a traffic aggregation point and may be responsible for paging, caching of subscriber profiles, routing to the core network 1209, and the like.

The air interface 1217 between the WTRUs 1202a, 1202b, and/or 1202c and the RAN 1205 may be defined as an R1 reference point that implements the IEEE 802.16 specification. In addition, each of the WTRUs 1202a, 1202b, and/or 1202c may establish a logical interface (not shown) with the core network 1209. The logical interface between the WTRUs 1202a, 1202b, and/or 1202c and the core network 1209 may be defined as an R2 reference point, which may be used for authentication, authorization, IP host configuration management, and/or mobility management.

The communication link between each of the base stations 1280a, 1280b, and/or 1280c may be defined as an R8 reference point that includes protocols for facilitating WTRU handovers and the transfer of data between base stations. The communication link between the base stations 1280a, 1280b, and/or 1280c and the ASN gateway 1282 may be defined as an R6 reference point. The R6 reference point may include protocols for facilitating mobility management based on mobility events associated with each of the WTRUs 1202a, 1202b, and/or 1202c.

As shown in FIG. 12D, the RAN 1205 may be connected to the core network 1209. The communication link between the RAN 1205 and the core network 1209 may defined as an R3 reference point that includes protocols for facilitating data transfer and mobility management capabilities, for example. The core network 1209 may include a mobile IP home agent (MIP-HA) 1284, an authentication, authorization, accounting (AAA) server 1286, and a gateway 1288. While each of the foregoing elements are depicted as part of the core network 1209, it will be appreciated that any one of these elements may be owned and/or operated by an entity other than the core network operator.

The MIP-HA may be responsible for IP address management, and may enable the WTRUs 1202a, 1202b, and/or 1202c to roam between different ASNs and/or different core networks. The MIP-HA 1284 may provide the WTRUs 1202a, 1202b, and/or 1202c with access to packet-switched networks, such as the Internet 1210, to facilitate communications between the WTRUs 1202a, 1202b, and/or 1202c and IP-enabled devices. The AAA server 1286 may be responsible for user authentication and for supporting user services. The gateway 1288 may facilitate interworking with other networks. For example, the gateway 1288 may provide the WTRUs 1202a, 1202b, and/or 1202c with access to circuit-switched networks, such as the PSTN 1208, to facilitate communications between the WTRUs 1202a, 1202b, and/or 1202c and traditional land-line communications devices. In addition, the gateway 1288 may provide the WTRUs 1202a, 1202b, and/or 1202c with access to the networks 1212, which may include other wired or wireless networks that are owned and/or operated by other service providers.

Although not shown in FIG. 12D, it should, may, and/or will be appreciated that the RAN 1205 may be connected to other ASNs and the core network 1209 may be connected to other core networks. The communication link between the RAN 1205 the other ASNs may be defined as an R4 reference point, which may include protocols for coordinating the mobility of the WTRUs 1202a, 1202b, and/or 1202c between the RAN 1205 and the other ASNs. The communication link between the core network 1209 and the other core networks may be defined as an R5 reference, which may include protocols for facilitating interworking between home core networks and visited core networks.

Although the terms device, server, and/or the like may be used herein, it may and should be understood that the use of such terms may be used interchangeably and, as such, may not be distinguishable.

Further, although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method for managing online security, the method comprising:
storing a first security profile associated with a first entity, wherein the first security profile indicates a first plurality of data elements associated with a user of the first entity, the first security profile further indicating one or more first actions associated with obtaining or changing one or more of the first plurality of data elements;
storing a second security profile associated with a second entity, wherein the second security profile indicates a second plurality of data elements associated with obtaining access to the second entity on behalf of the user, the second security profile further indicating one or more second actions associated with obtaining access to the second entity on behalf of the user;
receiving an indication of an activity relating to the first plurality of data elements or the one or more first actions;
determining that the activity creates a security risk to the user with respect to the second entity, wherein the security risk relates to the activity being capable of leading to unauthorized access to at least one of the second plurality of data elements or the one or more second actions; and
sending a warning about the security risk.

22. The method of claim 21, wherein the first security profile further indicates relationships between the first plurality of data elements or relationships between the one or more first actions, and wherein the second security profile further indicates relationships between the second plurality of data elements or relationships between the one or more second actions.

23. The method of claim 22, further comprising representing the first security profile with a first data structure and the second security profile with a second data structure, each of the first and second data structures including nodes and links that connect the nodes, wherein:
the nodes of the first data structure represent the first plurality of data elements or the one or more first actions,
the links of the first data structure represent the relationships between the first plurality of data elements or the relationships between the one or more first actions,
the nodes of the second data structure represent the second plurality of data elements or the one or more second actions, and
the links of the second data structure represent the relationships between the second plurality of data elements or the relationships between the one or more second actions.

24. The method of claim 23, further comprising assigning a probability to each of the links of the second data structure, wherein the probability corresponding to each of the links indicates a likelihood of obtaining access to one of the second plurality of data elements or one of the second actions associated with the link based on another one of the second plurality of data elements or another one of the second actions associated with the link, and wherein determining that the activity creates a security risk to the user with respect to the second entity comprises:
identifying one or more of the links that are subject to unauthorized access because of the activity,
calculating an overall probability of security breach based on the respective probabilities assigned to the one or more of the links, and
determining that the overall probability exceeds a threshold.

25. The method of claim 23, wherein at least one of the first or second data structure includes a form of a graph.

26. The method of claim 21, further comprising providing a recommendation to at least one of the first entity or the second entity for eliminating the security risk.

27. The method of claim 21, wherein the activity comprises the user providing one of the first plurality of data elements to the first entity or performing at least one of the one or more first actions.

28. A device, comprising:
a processor configured to:
store a first security profile associated with a first entity, wherein the first security profile indicates a first plurality of data elements associated with a user of the first entity, the first security profile further indicating one or more first actions associated with obtaining or changing one or more of the first plurality of data elements;
store a second security profile associated with a second entity, wherein the second security profile indicates a second plurality of data elements associated with obtaining access to the second entity on behalf of the user, the second security profile further indicating one or more second actions associated with obtaining access to the second entity on behalf of the user;
receive an indication of an activity relating to the first plurality of data elements or the one or more first actions;
determine that the activity creates a security risk to the user with respect to the second entity, wherein the security risk relates to the activity being capable of leading to unauthorized access to at least one of the second plurality of data elements or the one or more second actions; and
send a warning about the security risk.

29. The device of claim 28, wherein the first security profile further indicates relationships between the first plurality of data elements or relationships between the one or more first actions, and wherein the second security profile further indicates relationships between the second plurality of data elements or relationships between the one or more second actions.

30. The device of claim 29, wherein the processor is further configured to represent the first security profile with a first data structure and the second security profile with a second data structure, each of the first and second data structures including nodes and links that connect the nodes, wherein:
the nodes of the first data structure represent the first plurality of data elements or the one or more first actions,
the links of the first data structure represent the relationships between the first plurality of data elements or the relationships between the one or more first actions,
the nodes of the second data structure represent the second plurality of data elements or the one or more second actions, and
the links of the second data structure represent the relationships between the second plurality of data elements or the relationships between the one or more second actions.

31. The device of claim 30, wherein the processor is further configured to assign a probability to each of the links of the second data structure, wherein the probability corresponding to each of the links indicates a likelihood of obtaining access to one of the second plurality of data elements or one of the second actions associated with the link based on another one of the second plurality of data elements or another one of the second actions associated with the link, and wherein the processor being configured to determine that the activity creates a security risk to the user with respect to the second entity comprises the processor being configured to:
identify one or more of the links that are to subject to unauthorized access because of the activity,
calculate an overall probability of security breach based on the respective probabilities assigned to the one or more of the links, and
determine that the overall probability exceeds a threshold.

32. The device of claim 30, wherein at least one of the first or second data structure includes a form of a graph.

33. The device of claim 28, wherein the processor is further configured to provide a recommendation to at least one of the first entity or the second entity for eliminating the security risk.

34. The device of claim 28, wherein the activity comprises the user providing at least one of the first plurality of data elements to the first entity or performing at least one of the one or more first actions.

35. The device of claim 28, wherein at least one of the first entity or the second entity includes an online service accessible via a website.

36. The device of claim 28, wherein the first or second plurality of data elements includes at least one of a login, a password, a security question answer, or personal information about the user.

37. The device of claim 28, wherein the first plurality of data elements includes personal information about the user that is unrelated to the user's access to the first entity, and wherein the activity is associated with the user providing the personal information to the first entity.

38. The device of claim 28, wherein the one or more first actions or the one or more second actions include resetting a password or an email address associated with the user.

39. The device of claim 28, wherein the activity is associated with a security policy change at the first entity.

40. A system, comprising:
one or more devices configured to:
store a first security profile associated with a first entity, wherein the first security profile indicates a first plurality of data elements associated with obtaining access to the first entity on behalf of a user, the first security profile further indicating one or more first actions associated with obtaining access to the first entity on behalf of the user;
store a second security profile associated with a second entity, wherein the second security profile indicates a second plurality of data elements associated with obtaining access to the second entity on behalf of the user, the second security profile further indicating one or more second actions associated with obtaining access to the second entity on behalf of the user;
receive an indication of an activity relating to the first plurality of data elements or the one or more first actions;
determine that the activity creates a security risk to the user with respect to the second entity, wherein the security risk relates to the activity being capable of leading to unauthorized access to at least one of the second plurality of data elements or the one or more second actions; and
send a warning about the security risk.
